(19) United States
(12) Patent Application Publication
(10) Pub. No.: US 2022/0099227 A1
(43) Pub. Date: Mar. 31, 2022

(54) MANIFOLD FOR SERVICING MULTIPLE WELLS AND METHOD

(71) Applicant: ISOLATION EQUIPMENT SERVICES INC., Red Deer (CA)

(72) Inventor: Boris (Bruce) P. CHEREWYK, Calgary (CA)

(21) Appl. No.: 17/477,329

(22) Filed: Sep. 16, 2021

Related U.S. Application Data
(60) Provisional application No. 63/083,715, filed on Sep. 25, 2020.

(51) Int. Cl. F16L 41/03; E21B 43/26

(52) U.S. Cl. CPC F16L 41/03; E21B 43/2607

(57) ABSTRACT

A system and method is provided for maintaining a live bore throughout a manifold of a fluid flow system while providing fluid flow to two or more wellbores. At least two fluid inlet portions and at least one intermediate inlet portion located between the two fluid inlet portions deliver fluid to the live bore. The two fluid inlet portions straddle two or more outlet portions which are in communication with the two or more wellbores. One or more or all of the inlet portions or outlet portions can have multiple flow-impinging ports for reducing fluid velocity at each inlet and outlet portion. A diverter line can be provided to divert fluid from the first or second inlet portions to the intermediate inlet portions to equalize fluid flow streams in the manifold.

### CROSS-REFERENCE TO RELATED APPLICATIONS

This application claims the benefit of U.S. Provisional Patent application Ser. No. 63/083,715, filed Sep. 25, 2020, the entirety of which is incorporated herein by reference.

### FIELD

Embodiments disclosed herein generally relate to systems and methods for servicing wells with a fluid and, more particularly, to a system and method for flowing fluids through manifold(s) to wellhead assemblies to minimize the erosive effects of treatment fluids and operational difficulties associated with dormant flow zones in components and piping of the system.

### BACKGROUND

There are an increasing number of subterranean hydrocarbon reservoirs which are accessed using multiple wells for optimizing production therefrom. The wells and wellheads connected thereto are often closely spaced, the wellbores being angled downwardly and radially outwardly from a central location, such as a well pad, to access as much of the reservoir as possible.

Many or all of the multiple pay zones in such reservoirs may be characterized by low permeability or other characteristics which require treatment, such as stimulation, of one or more of the wells for increasing production therefrom. During selective treatment of the wells, which may include fracturing operations performed on one well (an “active” well), operations may be also be performed on other wells (“resting” wells), such as to shift wellbore access from one zone of the well to another.

To consolidate pumping equipment, such as fluid pumpers and sand supply for use in fracturing, it is known to employ a common manifold to selectively connect a source of fracturing fluid to one or more of the wellheads of the multiple wells. Thus, multiple wells can be stimulated from a common manifold or trains of multiple manifolds.

Herein, the term “frac piping” includes the manifold, fluid lines to the manifold, and frac lines from the manifold to the wells. Further, while various proppants are known, a common proppant is sand, and herein the term “sand” is used as shorthand for all proppants.

To facilitate well stimulation operations on a multiple-well reservoir, a method called “zipper manifold fracking” is often used. In a typical zipper manifold fracking configuration, multiple wells are typically connected to a fracturing fluid pumper through a manifold and an active well is stimulated while a resting well or wells is being maintained or serviced. During fracturing operations, the manifold is actuated to fluidly connect a first well W1 to the pumper while the remaining wells W2 . . . Wn are isolated therefrom.

The first well W1 is stimulated at a selected stage or zone, usually starting at the first stage. After stimulation, the manifold valves are actuated to isolate the first well W1 and fluidly connect the second well W2 to the pumper for stimulation of its designated stage, which is typically also its first stage. While the second well W2 is being stimulated, the first well W1 can be maintained, manipulated, or both. For example, a wireline can be run down the first well W1 to set a bridge plug and perforate the subsequent stage of the first well W1 to prepare it for stimulation. After stimulation operations are complete at the designated stage of the second well W2, the second well is isolated and the first well W1 is once again fluidly connected to the pumper for stimulation operations on a subsequent stage of the first well. In the meantime, a wireline can be run down the second well W2 to set the bridge plug, and perforate the second stage of the second well. Wells W3 through Wn can be similarly inserted into the operation. Such operations continue until all desired stages are stimulated in all desired wells.

As shown in FIGS. 1A, 1B and 1C, a conventional manifold is used for fracking multiple-well reservoirs. The manifold, typically receives the entirely of the fracturing fluid F, from the frac fluid source, at an inlet located at a mid-point along the manifold. Fluid outlets in communication with the wells are spaced along the manifold in both directions from the inlet. The frac fluid F typically travels in a first direction to the outlet associated with one or more wells, for example well W1, as shown in FIGS. 1A and 1B, and then, per operations, flow is switched to travel in a second direction to one or more other wells, such as well W2, shown in FIG. 1C. The conventional single-well treatment operations, as described, result in localized high velocities of sand laden fluids and alternating stagnant or dormant areas of the manifold.

The erosive nature of the stimulation fluids F necessitates regular manifold maintenance. Stimulation fluids F typically have high fluid flow rates and flow velocity, and are conventionally directed around right angle corners of manifold fittings and other components, resulting in significant wear to the manifold, manifold valves, as well as to downstream equipment. Sand in the fracturing fluids F further exacerbates erosive effects.

It is known to stockpile replacement manifold components onsite, including new flow blocks and valves, for replacing damaged and eroded components as the job proceeds. It is also known to have redundant fluid pumpers on standby, the redundancy required to maintain simultaneous and continuous stimulation despite the increased costs.

With reference to FIGS. 1B and 1C, in a further disadvantage, the conventional fluid flow path to the active well bypasses other unused areas of the manifold, those unused areas being temporarily dead ended or stagnant. Sand in the current fluid flow can encroach and accumulate in such stagnant areas. When operations switch to the next well and fluid is directed through the recently stagnant areas, the fluid can inject a slug of accumulated sand downstream to the wellhead and downhole into the well. Such slugs of sand have been known to damage equipment and/or obstruct the wellbore stage being stimulated. This may require a stage of a well to be prematurely shut down to clean out the sand plug(s) with coil tubing, which can be costly.

Further, in cold weather environments, freezing can become a problem during such intermittent fracking operations, as residual water-based fluid can freeze in the stagnant or dormant areas of the frac piping, including the manifold itself, fracturing stack, and various fluid lines when a well is resting in between fracturing stages. As it can take hours for stimulation operations to complete in the active well, fluid in the resting wells has ample time to freeze in cold conditions.

To mitigate freezing, it is conventional to wrap heat tracing such as insulated hot glycol or steam heating hoses around the various frac piping and the like to warm the components and fluid therein. However, the installation and use of heating hoses is time consuming, costly and, should the heater or heating hoses fail, the entire system could freeze before failure is detected, necessitating costly repairs and downtime. Typically, installing heating hoses around a manifold, fracturing stacks, and other components can take several days. Additionally, as the heat source is typically a boiler, a failure of the boiler compromises the entire heating system. Further still, boilers for heating systems are often controlled remotely, which adds to the risk of delayed detection failures by personnel. The replacement of components of the heating system can be costly as it requires time to disassemble, partially remove and replace damaged or eroded components and reassemble.

With reference to FIGS. 1D and 1E, in some manifold systems, such as that disclosed in US 2018/0179848A1 to Cherewyk, incorporated herein in its entirety, fluid is introduced at two or more inlet portions located at extremities of the manifold, typically at the opposing terminal ends of a linear manifold. Two or more outlet portions of the manifold are connected to the wellheads of two or more wells and are located intermediate the inlet portions. Such a configuration provides a constant flow in all portions of the manifold during individual treatment of the wells, regardless of which well is being treated, thus avoiding stagnant areas for sand and other solids to accumulate. Further, the velocity of the fluid in the manifold is reduced as the fluid flow rate into the manifold via the inlet portions are approximately halved relative to a single-inlet manifold, as the fluid supply is split between the two or more inlet portions rather than only flowing through one inlet portion.

For example, with reference to FIG. 1D, if 100 units of fluid is to be delivered to well W1, then 50 units of fluid can be introduced at each of the inlet portions located at the terminal ends of manifold. In such an arrangement, fluid flow is present at all portions of the manifold bore, rendering all portions of the bore “live” regardless of which well is to be treated, avoiding stagnant areas where and buildup may occur, and mitigating freezing of stagnant fluid within the manifold. In addition to the flow velocity being reduced by splitting the fluid supply to the manifold into two fluid streams, velocity and energy are further reduced as the flow streams converge within the manifold and impinge on one another as they meet and turn to flow out of the outlet portion of the manifold corresponding to the selected well W1. As can be seen in FIG. 1E, if W2 is subsequently selected to be the active well and flow to well W1 is shut off, fluid still flows through the entirety of the live bore to well W2 such that there are no areas of dormant flow in the live bore.

In some situations, with reference to FIG. 2B, it may be desirable to treat two or more wells simultaneously. In such instances, stagnant or dormant zones D may exist in the manifold even when fluid is introduced at both ends of the manifold. For example, the intermediate area of the manifold bore located between the outlet portions corresponding to the wells W1,W2 to be simultaneously treated may experience reduced or dormant flow due to fluid being introduced via the inlet portions located at opposing ends of the manifold bore and exiting the bore via the outlet portions prior to reaching said intermediate area. This can again lead to sand accumulation and potential freezing problems as discussed above. Moreover, the impinging action of the two opposing fluid streams may be reduced or absent, as a significant portion of the flow from the streams may exit the manifold bore via the outlet portions, leaving little flow to reach and impinge the other stream. This may result in increased erosion of the manifold and nearby components at the location of directional change of the fluid streams due to the resulting turbulence and high fluid velocity.

The pressures and volumes of high pressure frac fluids in well treatment operations place equipment and personnel at risk. There is a continuing need in the industry for a method to minimize erosion in the manifold and related frac piping, and to minimize stagnant or dormant areas with the associated sand accumulation and risk of freezing during down periods and between cycles.

### SUMMARY

Embodiments herein are directed to an apparatus, system, and method of selectively treating two or more wells from at least one common fluid source using one or more common manifolds, each manifold servicing one or more wells, such as in a simultaneous treatment operation. A fluid, such as a sand-laden fracturing fluid, is pumped through the one or more manifolds to selected wells of the one or more wells. Manifold piping includes the manifold, fluid lines to the manifold, and frac lines from the manifold.

Fluid is delivered to the manifold at opposing first and second inlet portions as well as one or more intermediate inlet portions located between the first and second inlet portions. The manifold can further comprise two or more outlet portions each corresponding to a well. The intermediate inlet portions can be located between at least two of the outlet portions, and the wells to be treated with fluid can be selected such that at least one intermediate inlet portion is located between each adjacent pair of active outlet portions corresponding to the wells to be treated. In operation, fluid can be delivered to the first and second inlet portions and the intermediate inlet portions located between the active outlet portions, while the valves of the inactive outlet portions are actuated to prevent fluid from travelling out of the manifold therethrough. In such a manner, the bore of the manifold is always live, even during operations where two or more wells are treated simultaneously.

Fluid can be supplied to the intermediate inlet portions by discrete fluid supply lines connected directly to a fluid source, or fluid can be diverted to the intermediate inlet portions from the first and second supply lines of the first and second inlet portions. Fluid can also be diverted from the first and second supply lines in the case of single well treatment operations to equalize incoming flows to the active outlet portion corresponding to the selected well to be treated, such incoming flowing otherwise being unequal due to line losses caused by a longer travel path from the fluid source one of the first and second inlets.

In a broad aspect, a system is provided for delivering fluid from a fluid source to two or more wells, comprising: a manifold having a main axial bore; a first inlet portion located at a first end of the manifold and a second inlet portion located at a second end of the manifold; two or more outlet portions, comprising at least a first outlet portion in communication with a first well of the two or more wells and a second outlet portion in communication with a second well of the two or more wells; at least one intermediate inlet portion located intermediate the first outlet portion and the second outlet portion; wherein the first, second, and at least one intermediate inlet portions are in communication with the fluid source.

In an embodiment, the two or more outlet portions comprise a plurality of outlet portions, each outlet portion in communication with a respective one of the two or more wells; and the at least one intermediate inlet portion comprises a plurality of inlet portions, each inlet portion located between a respective pair of outlet portions of the plurality of outlet portions.

In an embodiment, the two or more outlet portions comprise a plurality of outlet portions, each outlet portion in communication with a respective one of the two or more wells; and the at least one intermediate portion comprises an intermediate inlet portion located at an intermediate point between the plurality of outlet portions.

In an embodiment, the first and second inlet portions receive fluid from the fluid source via respective first and second inlet lines, and the at least one intermediate inlet portion receives fluid from the fluid source via a respective at least one intermediate fluid line.

In an embodiment, the first and second inlet portions receive fluid from the fluid source via respective first and second inlet lines; and the at least one intermediate inlet portion receives fluid diverted from one or both of the first and second inlet lines via at least one diverter line.

In an embodiment, the at least one diverter line comprises a trunk line in communication with one or both of the first and second inlet lines and one or more branch lines, each branch line in communication with the trunk line and a corresponding inlet portion of the at least one intermediate inlet portion.

In an embodiment, each outlet portion comprises a corresponding outlet valve configured to selectively permit fluid flow out of the manifold through the outlet portion.

In an embodiment, each intermediate inlet portion comprises a corresponding inlet valve configured to selectively permit fluid flow into the manifold through the intermediate inlet portion.

In another broad aspect, a system for delivering fluid from a fluid source to one or more wells is provided, comprising: a manifold having a main axial bore; a first inlet portion located at a first end of the manifold and a second inlet portion located at a second end of the manifold; one or more outlet portions, each outlet portion in communication with a respective one of the one or more wells; at least one intermediate inlet portion located intermediate at least one of the one or more outlet portions and the second inlet portion; wherein the first and second inlet portions are in communication with the fluid source via respective first and second inlet lines; and wherein the at least one intermediate inlet portion received fluid diverted from one or both of the first and second inlet lines via at least one diverter line.

In an embodiment, the diverter line is configured to divert fluid from the first inlet line, and a bore size of the first inlet line is larger than a bore size of the second inlet line.

In an embodiment, the at least one intermediate inlet portion is located between a pair of outlet portions of the one or more outlet portions.

In another broad aspect, a method is provided for delivering fluid form a fluid source to two or more wells, comprising: introducing fluid from the fluid source to a manifold at a first inlet portion located at a first end of the manifold, a second inlet portion located at a second end of the manifold, and one or more intermediate inlet portions located between the first inlet portion and the second inlet portion; and directing fluid out of the manifold via at least two active outlet portions of two or more outlet portions of the manifold, each of the two or more outlet portions in communication with a respective well of the two or more wells; wherein at least one of the one or more inlet portions is located between the at least two active outlet portions.

In an embodiment, fluid is introduced to the first inlet portion via a first fluid line, and fluid is introduced to the second inlet portion via a second fluid line, and further comprising the step of diverting fluid from one or both of the first and second fluid lines to the at least one or more intermediate inlet portions.

In an embodiment, the second fluid line is longer than the first fluid line, and the step of diverting the fluid comprises diverting fluid from the first fluid line.

In an embodiment, the step of diverting the fluid comprises diverting fluid from the first fluid line, and further comprising providing fluid from the fluid source to the first inlet portion at a first fluid flow rate greater than a second fluid flow rate of fluid provided to the second inlet portion.

In an embodiment, the first flow rate is about three times greater than the second fluid flow rate, and a diverter flow rate through the diverter line is about two times greater than the second flow rate.

In an embodiment, the at least two outlet portions comprise at least two groups of outlet portions; wherein each of the one or more intermediate inlet portions is located between a respective adjacent pair of groups of the at least two groups of outlet portions; and the at least two active outlet portions comprise at least one outlet portion from each group of the at least two groups of outlet portions.

In an embodiment, each of the one or more intermediate inlet portions is located between a respective adjacent pair of the two or more active outlet portions.

In an embodiment, the fluid flow received at the first and second inlet portions comprises is one-half of the fluid flow to be directed out of each active outlet portion, and the fluid flow received at each of the at least one intermediate inlet portion is equal to the fluid flow to be directed out of each active outlet portion.

In an embodiment, the step of introducing fluid to the one or more intermediate inlet portions further comprises directing fluid through at least one pair of radially opposing inlet ports of the one or more intermediate inlet portions for causing fluid streams travelling therethrough into the manifold to impinge on each other.

### BRIEF DESCRIPTION OF THE DRAWINGS

FIG. 1A is an embodiment of a prior art manifold system;

FIG. 1B is a schematic representation of a supply of 100 units of frac flow to a first well using a prior art manifold system;

FIG. 1C is a schematic representation of a supply of 100 units of frac flow to a second well using the prior art manifold system of FIG. 1B;

FIG. 1D is a schematic representation of a supply of 100 units of frac flow to a first well, supplying 50 units from each of two opposing ends of a prior art linear header or manifold system;

FIG. 1E is a schematic representation of a supply of 100 units of frac flow to a second well, supplying 50 units from each of two opposing ends of the manifold of FIG. 1D;

FIG. 2A is a longitudinal partial cross-sectional view of an embodiment of a manifold system described herein, illustrating a common contiguous live bore header and a plurality of outlets fluidly connected thereto for controlled delivery fluid to multiple wellheads. A flow path is shown for delivery of fracturing fluid through the manifold to two wells simultaneously;

FIG. 2B is a schematic representation of a supply of 100 units of frac flow to two wells each, supplying 100 units from each of two opposing ends of a manifold system, with an area of dormant flow located between the two wells;

FIG. 2C is a schematic representation of a supply of 100 units of frac flow to two wells each, supplying 50 units from each of two opposing ends of the manifold and 100 units from an intermediate inlet portion located between the two opposing ends;

FIG. 3A is a schematic representation of the relative fluid flow rates and units of flow at the inlet portions, outlet portions, and live bore of an embodiment of a manifold system;

FIGS. 3B1 through 3B5 respectively are isometric representations of the management of various fluid flow options for the schematic of FIG. 3B, namely:

FIG. 3B1 illustrates an embodiment in which each only one outlet portion is active, the intermediate inlet portion is closed, and each inlet portion has one port for providing ½ of the total flow and the active outlet portion has two outlet ports for discharging ½ of the total flow;

FIG. 3B2 illustrates an embodiment in which each only one outlet portion is active, the intermediate inlet portion is closed, and one half of the frac fluid is provided at each end of two ends of the live bore, one of two inlet portions providing one inlet port for ½ of the total flow and the second inlet portion having three inlet ports, each providing ⅙ of the total flow, the second inlet portion totaling ½ of the total flow;

FIG. 3B3 illustrates an embodiment in which each only one outlet portion is active, the intermediate inlet portion is closed, and one half of the frac fluid is provided at each end of two ends of the live bore, each of the two inlet portions have three inlet ports for ⅙ for the total flow at each port combining to total ½ of the total flow at each inlet portion;

FIG. 3B4 illustrates an embodiment in which each only one outlet portion is active, the intermediate inlet portion is closed, and each inlet portion has one port for providing ½ of the total flow, and wherein the active fluid outlet portion has four outlet ports, each of which discharges ¼ of the total flow;

FIG. 3B5 illustrates an embodiment in which both outlet portions are active and the intermediate inlet portion is open, wherein the inlet portions at the ends of the manifold has three inlet ports providing 1/12 of the total flow, the intermediate inlet portion between the active outlet portions have two inlet ports providing ¼ of the total flow, and wherein both active outlet portions have two outlet ports, each of which discharges ¼ of the total flow;

FIG. 4 is a cross-sectional view of a block of the fluid inlet portion of FIG. 2A, illustrating inlet ports for receiving from a fluid source;

FIG. 5 is a cross-sectional view of a block of the fluid outlet portion of FIG. 2A, illustrating outlet ports for fluidly connecting to a wellhead;

FIG. 6A is a schematic representation of an embodiment of a methanol flushing system for flushing the manifold and wellhead components, such as those of FIG. 2A, with the manifold configured to circulate methanol from a source, through a fluid outlet portion corresponding to a first well and back to the source;

FIG. 6B is a schematic representation of the methanol flushing system of FIG. 6A with the manifold configured to flow methanol through a fluid outlet portion corresponding to a second well;

FIG. 6C is a schematic representation of an embodiment of a methanol flushing system for flushing the manifold and wellhead components, such as those of FIG. 2A, with the manifold configured to circulate methanol from a source, through fluid outlet portions corresponding to first and second wells simultaneously and back to the source;

FIG. 6D is a schematic representation of an embodiment of a methanol flushing system for flushing the manifold and wellhead components, with the manifold configured to flow methanol through a fluid outlet portion in fluid communication with a respective fracturing stack;

FIG. 7 is a flow diagram setting out an example process for flushing a manifold system and wellhead components with methanol;

FIG. 8 illustrates a prior art Chiksan® swivel connection with quick release wing union connections;

FIG. 9 is a cross-sectional view of a swivel connection with flanged connections according to one embodiment;

FIG. 10A is a perspective view of the connections between a manifold and two fracturing stacks employing swivel connections, each stack having two fracturing lines connecting the stack to the manifold;

FIG. 10B is an alternative perspective view of the connections between a manifold and fracturing stacks of FIG. 9A;

FIG. 11 is a perspective view of the connections between a manifold and two fracturing stacks having an alternative swivel configuration;

FIG. 12 is a perspective view of a fracturing stack having swivel connections to fluidly connect the fracturing stacks and the manifold;

FIG. 13A illustrates an embodiment of a manifold flow system having a supplementary fluid inlet located between two outlet portions;

FIG. 13B illustrates a schematic representation of a manifold flow system having a supplementary fluid inlet located intermediate multiple outlet portions;

FIG. 13C illustrates a schematic representation of a manifold flow system supplying fluid to two supplementary fluid inlet portions each located intermediate a pair of adjacent active outlet portions to treat three wells;

FIG. 13D depicts the manifold flow system of FIG. 13C configured to treat two wells, where one outlet portion and one intermediate inlet portion are deactivated;

FIG. 13E depicts the manifold flow system of FIG. 13C configured to treat two wells, where one outlet portion is deactivated and two intermediate inlet portions receive fluid;

FIG. 14A illustrates the embodiment of FIG. 13 where in the supplementary fluid inlet portion is fed from a diverter line in communication with one of the inlet portions;

FIG. 14B is a schematic representation of a manifold system wherein multiple supplementary fluid inlet portions are fed from a diverter line diverting fluid from one inlet portion;

FIG. 14C is a schematic representation of a manifold system wherein multiple supplementary fluid inlet portions are fed from a diverter line diverting fluid from two inlet portions;

FIG. 15A illustrates an embodiment having multiple wells and an intermediate fluid inlet fed from a diverter line; and

FIG. 15B illustrates an embodiment having multiple wells and an intermediate fluid inlet fed from a diverter line, wherein two wells are treated simultaneously and the diverter line equalizes flow at the outlet portions corresponding to the treated wells.

### DESCRIPTION

Embodiments of a manifold and fluid flow system for treating multiple wells, and maintenance thereof, are described herein. Embodiments described herein are suitable for delivery of a variety of treatment or stimulation fluids, but are generally described in the context of the flow of fracturing fluid in a fracturing operation. Particular advantages are obtained when using embodiments of the invention for delivering water-based fracturing fluids F which further carry a particulate sand P therein. References to sand P include sand and other proppant typically used in well stimulation operations.

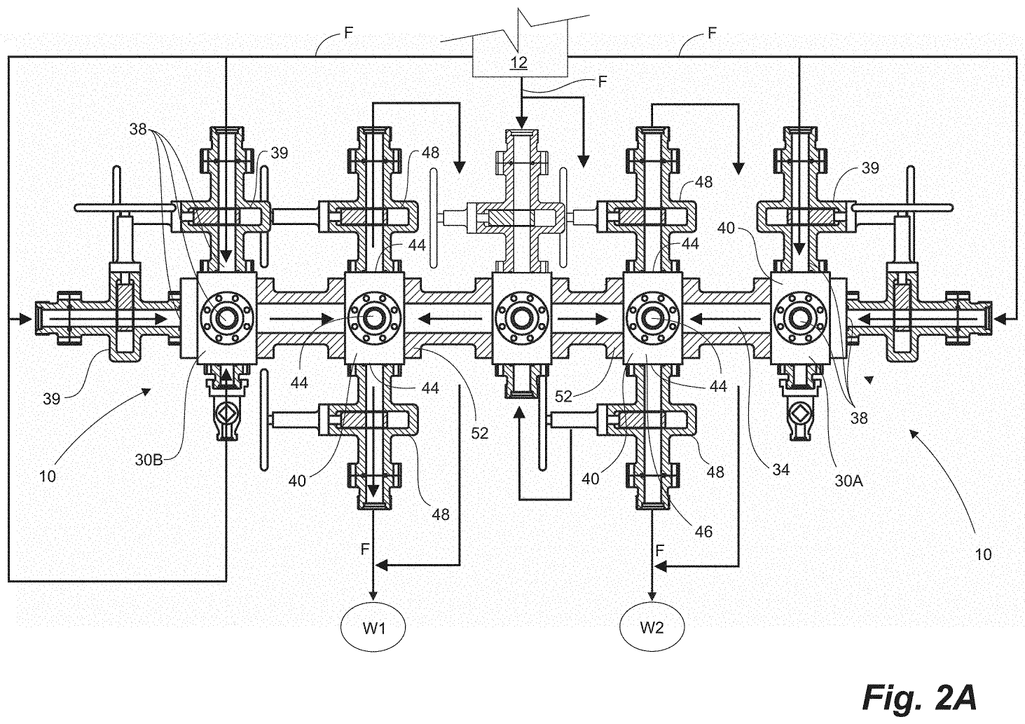

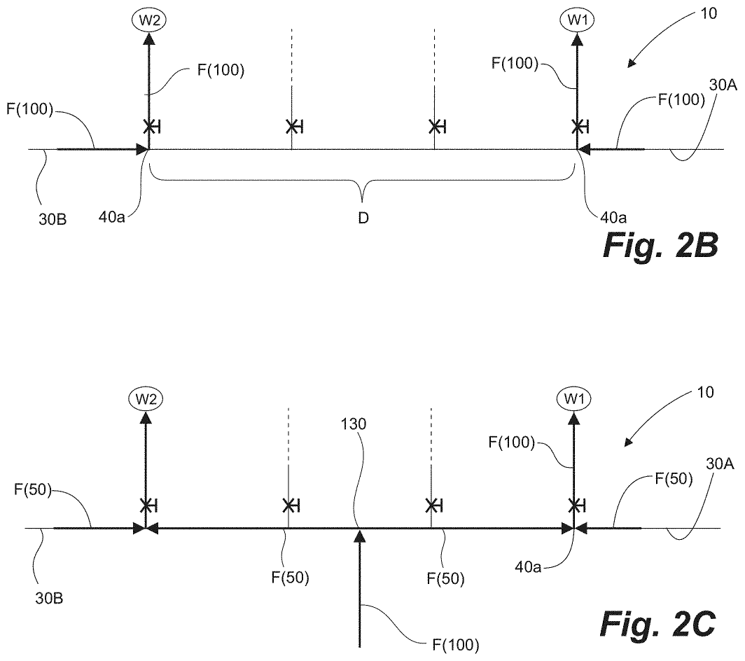

With reference to FIG. 2A, in an embodiment, a manifold 10 receives frac fluid from a source 12; the manifold comprising an axial manifold bore 34 extending therethrough. Fluid outlet portions 40 are spaced along the manifold and each outlet portion 40 can have one or more outlet ports 44 configured for fluid communication of frac fluid F between the bore 34 and wells W. In embodiments, each fluid outlet portion 40 is assigned to a corresponding well W and outlet valves 48 can be positioned in-line with each of the outlet ports 44 of each outlet portion 40 for selectably discharging of frac fluid F therefrom. In this manner, each well W1,W2 . . . is independently connected to the manifold bore 34 via a respective fluid outlet portion 40,40 . . . for selective fluid communication or isolation from the manifold bore 34.

Two or more fluid inlet portions 30 are located on the manifold 10. Each fluid inlet portion 30 can have one or more inlet ports 38 for fluid communication of frac fluid F between the source 12 and the manifold bore 34. As shown in FIG. 2A, in one embodiment, one of the inlet ports 38 of the first and second fluid inlet portions 30A,30B is in-line with axial bore 34 of the manifold 10. In an embodiment, first and second fluid inlet portions 30A,30B bookend or straddle all the fluid outlet portions 40,40 . . . forming a live bore 34 therebetween. In operations wherein the wells W are treated individually, the fluid path from either of the first and second fluid inlet portions 30A,30B to the furthest fluid outlet portion 40 therefrom passes every other fluid outlet portion 40, so that the entirely of the manifold bore 34 between the first and second fluid inlet portions 30A,30B has fluid flowing therein regardless of which well is being treated. Inlet valves 39 can be positioned in-line with each of the inlet ports 38 for selectably permitting frac fluid F from the fluid source 12 to flow therethrough into the manifold bore 34.

When only one well is to be treated at a time, embodiments of the manifold 10 having only first and second inlet portions 30A,30B provide fluid flow through the entire manifold bore 34 regardless of which outlet portion 40 is currently active, i.e. in communication with its respective well W. Thus the bore 34 is live and absent stagnant areas. The live bore 34 prevents accumulation of sand P therein, and further mitigates freezing of fluid therein. However, with respect to FIG. 2B, when it is desired to pump treatment fluid F to two or more wells W simultaneously, for example during simultaneous fracking operations, portions of the manifold bore 34 intermediate active outlet portions 40a may experience areas of low or dormant flow D, and the flow at or proximate the active outlet portions 40a may not receive the full benefits of opposing fluid flow steams such as impingement and dissipation of energy prior to flowing out of the active outlet portions 40a. Because opposing fluid streams will not meet but rather turn to flow out of the manifold bore 34 upon reaching active outlet portions 40a, fluid impingement thereat may not occur or may be lessened, therefore risking significant erosion. Additionally, the areas of low or dormant flow D may accumulate sand and create a sand pack as the sand P replaces the fluid F. For example, when a blanking flange proximate such dormant areas is removed, it may be packed full of sand P. A similar condition may occur for closed valves proximate dormant flow areas D that are later re-opened. Sand plugs of this nature are undesirable as they can damage equipment and cause other problems when pumped into the wellbore. When components of a fracturing system are disassembled, it is not uncommon to discover occurrences of very dense sand packing regardless of the size and length of piping used. For example, a fracturing operation may commonly require periods of 90 to 150 minutes of pumping where sand volume of up to 500 tonnes is used. During a typical fracturing operation, there is a lengthy period of time for sand P to pack in portions of piping that are without fluid flow. Further, in cold weather environments, freezing can become a problem during intermittent fracking operations, as residual water-based fluid F can freeze in the dormant or stagnant areas D of the frac piping, including in the manifold 10 itself, fracturing stack, and various fluid lines when a well is resting in between fracturing stages. As it can take hours for stimulation operations to complete in the active well, fluid in the dormant areas D of the manifold bore 34 may freeze in cold conditions. Thus, maintaining constant flow in all areas of the manifold bore 34, and impingement of fluid in the manifold bore 34 at or proximate the active fluid outlet portions 40a, is desirable as it substantially reduces erosion of piping components as fluid energy is dissipated by the opposing fluid flows rather than by contact with piping components, and maintaining constant flow mitigates freezing of fluid F.

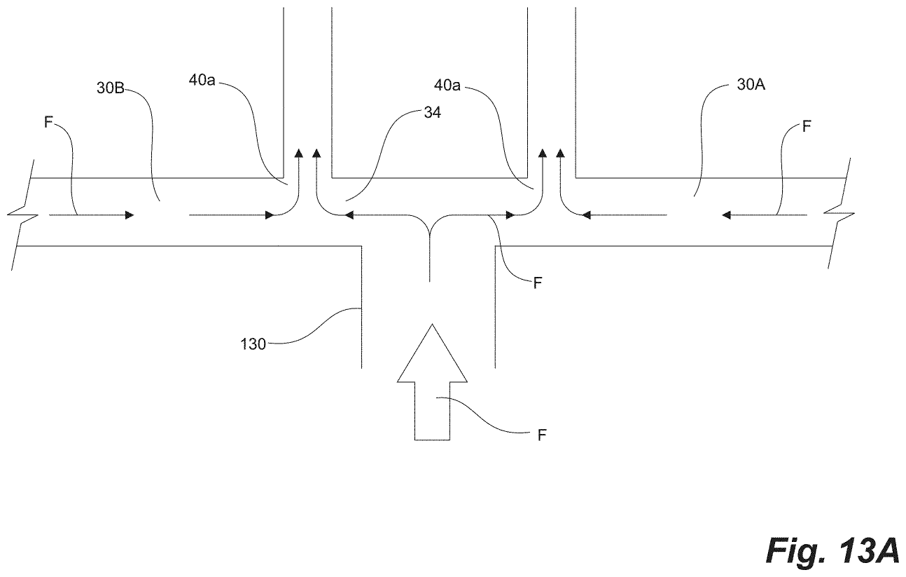

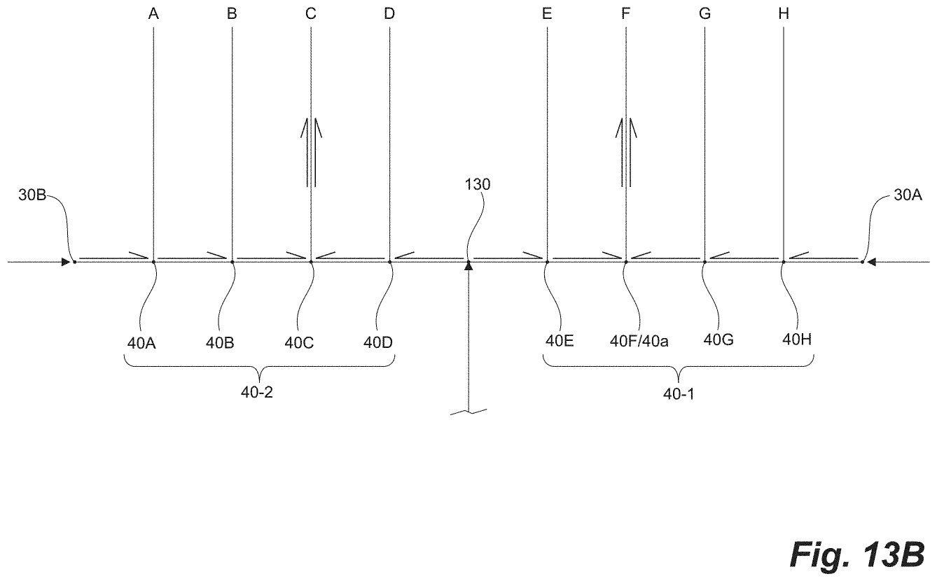

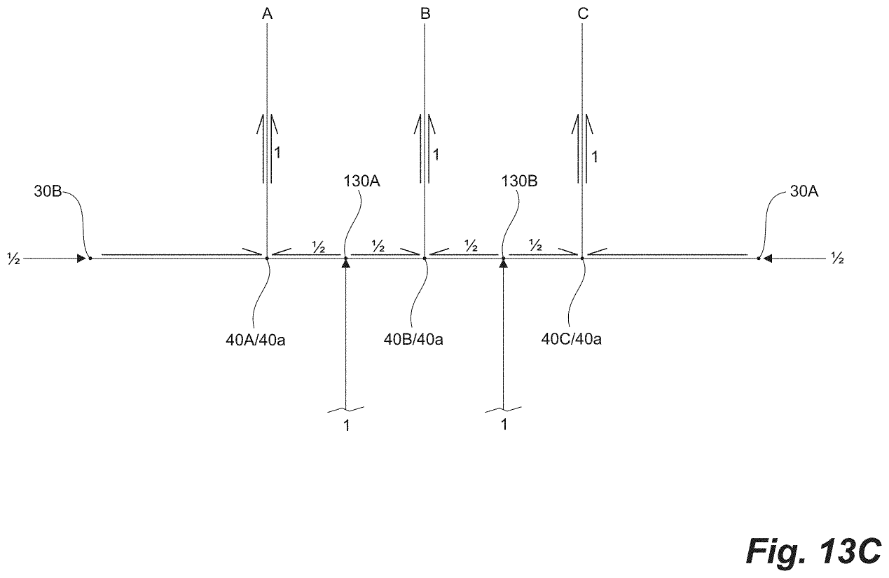

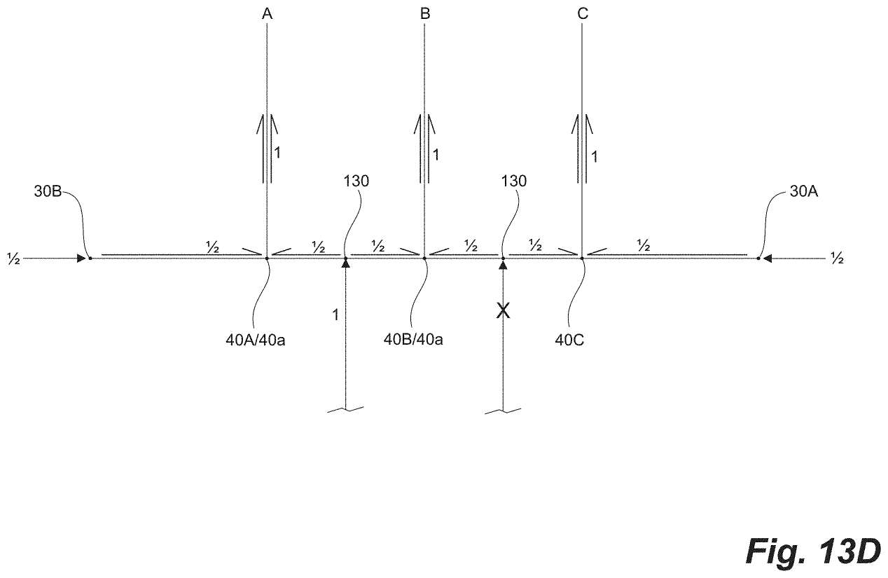

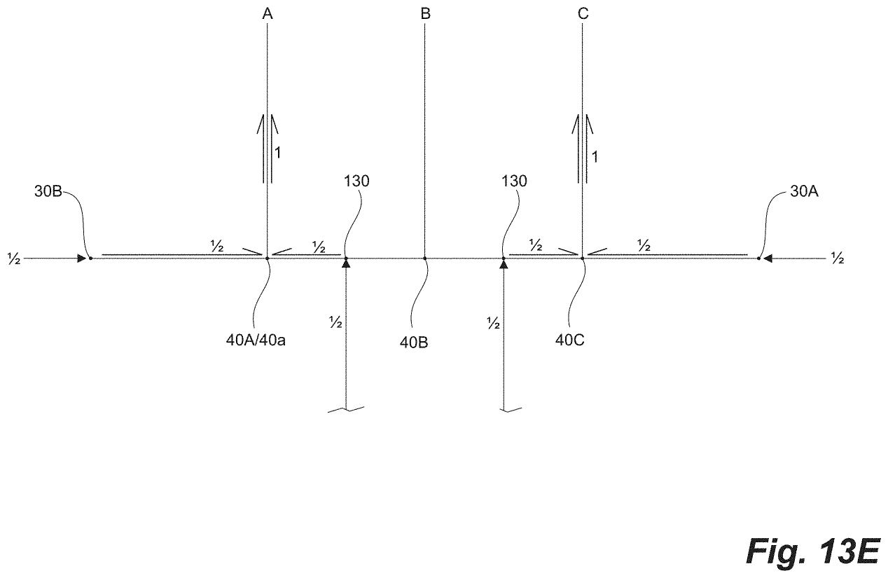

Referring to FIG. 13A, in an embodiment, the manifold 10 comprises an intermediate/supplementary fluid inlet portion 130. The intermediate fluid inlet portion 130 can have one or more intermediate inlet ports 38 for fluid communication of frac fluid F between the fluid source 12 and the manifold bore 34. The intermediate fluid inlet portion 130 is located between the first and second fluid inlet portions 30A,30B bookending the manifold bore 34. Further, the intermediate fluid inlet portion 130 is located between two or more of the fluid outlet portions 40,40. The intermediate fluid inlet 130 can be fed independently of the first and second fluid inlet portions 30A, 30B or can receive fluid F diverted from one or both of the fluid lines 31A,31B feeding the first and second fluid inlet portions 30A,30B, as described in greater detail below. The intermediate fluid inlet portion 130 may be located such that the fluid flow streams in the manifold bore 34 from the intermediate inlet portion 130 opposes the flow streams from one or both of the first and second fluid inlet portions 30A,30B to further encourage fluid impingement and reduce erosion.

With reference to FIG. 13B, in embodiments wherein a well pad has a plurality wells W, each corresponding to a respective outlet portion 40 located along the manifold 10, the intermediate fluid inlet portion 130 can be located at a mid-point of the manifold 10 between a first group of outlet portions 40-1 located between the intermediate inlet portion 130 and the first inlet portion 30a, and a second group of outlet portions 40-2 located between the intermediate inlet portion 130 and the second inlet portion 30b. The wells W can then be fracked in pairs, with one well W corresponding to an outlet portion 40 from the first group 40-1, and the other well W corresponding to an outlet portion 40 from the second group 40-2, such that the corresponding outlet portions 40 of each well pair are located on either side of the intermediate inlet 130. Such a configuration ensures that the intermediate inlet 130 provides fluid F to the otherwise dormant area D between the two active wells 40a,40a. For example, with reference to FIG. 13B, in a well pad with wells A through H and corresponding outlets 40A . . . 40H located along manifold 10, the intermediate inlet 130 can be located between wells 40D and 40E. The wells W to be simultaneously fracked can be chosen such that a first well is chosen from wells A through D, and a second well is chosen from E through H. In this manner, flow of fluid into the first and second inlet portions 30A,30B and intermediate inlet portion 130 ensure constant flow in all areas of the manifold bore 34. While FIG. 13B depicts an equal number of wells in the first and second groups 40-1,40-2, in other embodiments, the first and second groups can have different numbers of wells. So long as one of the pair of active wells 40a is selected to be on the first side of the intermediate inlet portion 130 and the other well of the pair of active wells 40b is selected to be on the second side, the fluid from the intermediate inlet portion 130 mitigates the presence of dormant flow areas D and provides fluid to impinge on the fluid flow streams from the first and second inlet portions 30A,30B. As one of skill in the art would understand, more than two groups of outlet portions 40 may be present along a manifold 10, with an intermediate inlet portion 130 located between each group of outlet portions 40. In other embodiments, more than two wells can be treated simultaneously. For example, wells C, D, E, and F can be treated at once using the system of FIG. 13B, and the fluid flow from intermediate inlet portion 130 mitigates the presence of dormant flow areas D. However, in such scenarios, there may still be dormant areas D located between outlet portions 40C and 40D, and between 40E and 40F, due to the flow from inlet portion 30A mostly leaving the manifold 10 at outlet portion 40F, the flow from inlet portion 30B mostly leaving the manifold at outlet portion 40C, and the flow from supplemental inlet portion 130 mostly leaving the manifold 10 at outlet portions 40D and 40E.

In embodiments, with reference to FIGS. 13C-13E, multiple intermediate fluid inlet portions 130 can be provided along the manifold 10 intermediate the first and second inlet portions 30A,30B. For example, as seen in FIG. 13C, a intermediate fluid inlet portion 130 can be located between each adjacent pair of outlets 40, with fluid being selectively being directed through at least the intermediate inlet portions 130 located intermediate the currently active outlet portions 40a. In some embodiments, only two of the wells A,B,C are treated simultaneously. In other embodiments, all of the wells A,B,C are treated at once. The intermediate fluid inlet portions 130 may also have a shut off valve to isolate the supplementary fluid if required. For example, with reference to FIG. 13D, if wells A and B are the selected wells, then outlet portions 40A and 40B are the active outlet portions 40a and fluid F can be introduced at first and second inlet portions 30A,30B and intermediate inlet portion 130A. Alternatively, if wells A and C are the selected wells, with reference to FIG. 13E, then outlet portions 40A and 40C are the active outlet portions 40a and fluid F can be introduced at the first and second inlet portions 30A,30B, and one or both of intermediate inlet portions 130A and 130B, as both intermediate inlet portions 130A,130B are located between the active outlet portions 40A and 40C. If all three wells A,B,C, are the selected wells, then outlet portions 40A,40B,40C are the active outlet portions 40a and fluid F can be introduced at the first and second inlet portions 30A,30B, and both intermediate inlet portions 130A,130B. As one of skill the art would understand, a manifold may comprise even greater numbers of outlet portions 40 with intermediate inlet portions 130 located between each adjacent pair of outlet portions 40, or between select pairs of outlet portions 40, to mitigate dormant areas D during simultaneous treatment of wells.

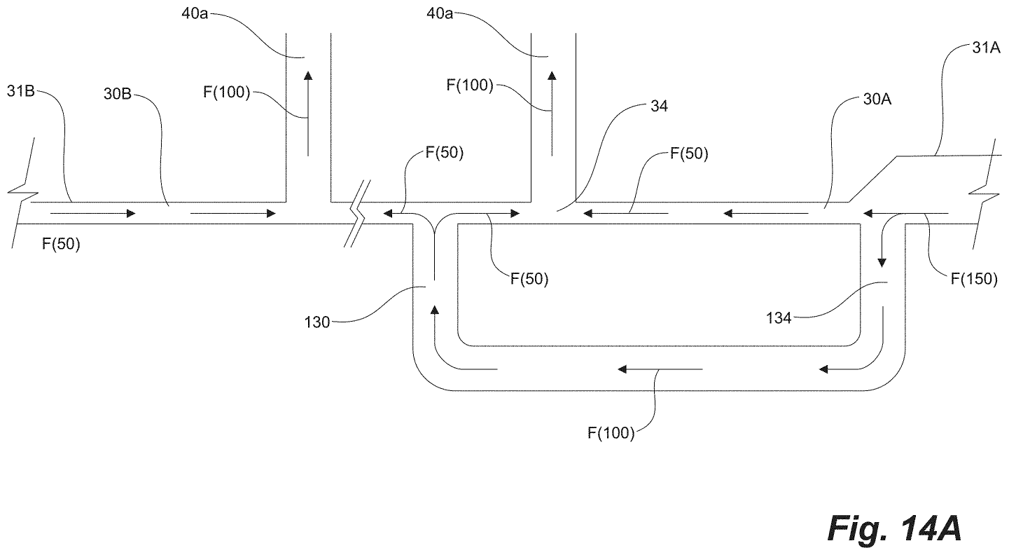

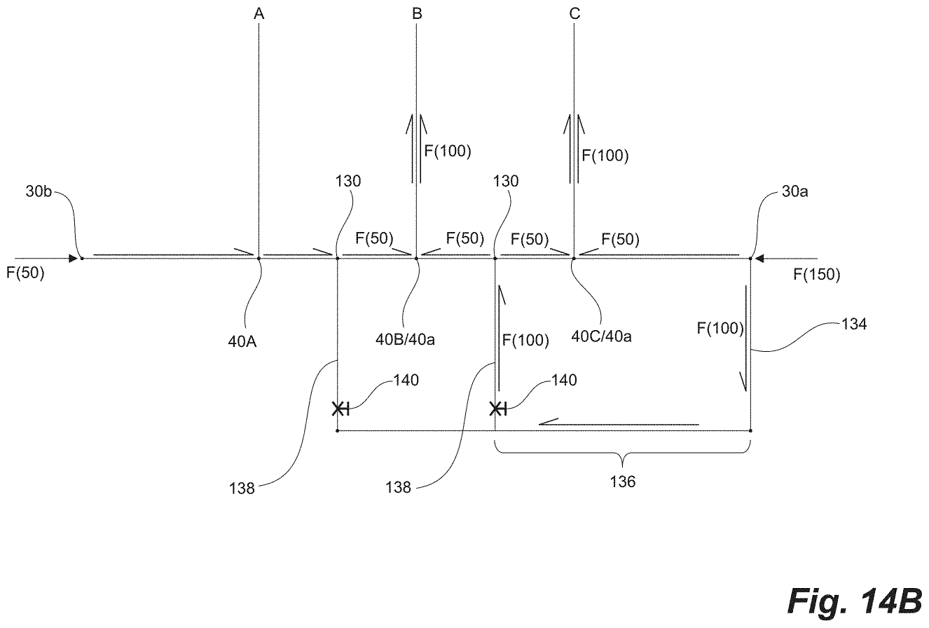

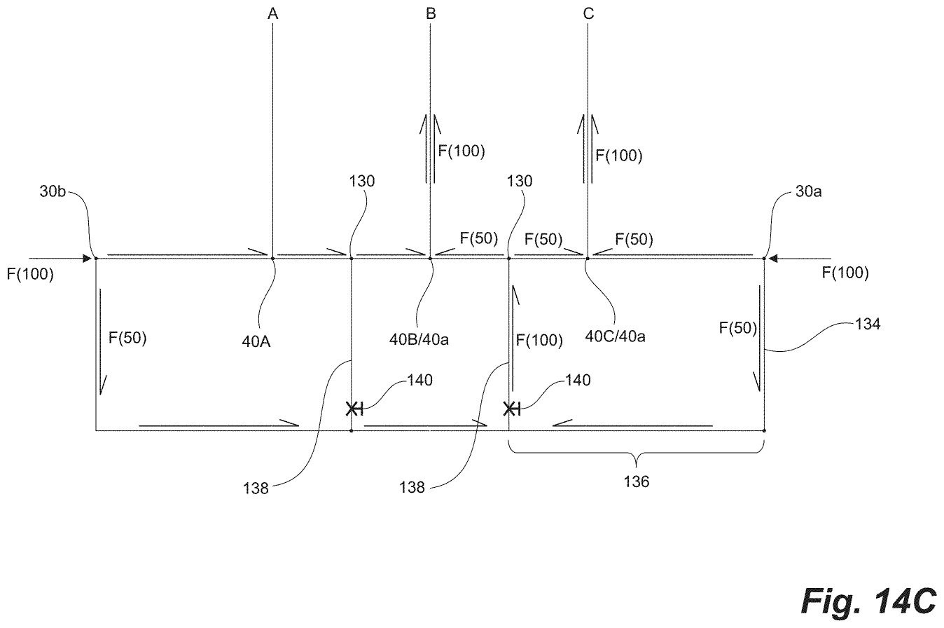

Referring to FIG. 14A, in an embodiment, the intermediate fluid inlet portion 130 receives fluid diverted via a diverter line 134 from the fluid line 31A feeding the first fluid inlet portion 30A rather than a fluid line connected directly to the fluid source 12. In embodiments, the system can be configured such that a greater volume flow rate of fluid is directed toward the first fluid inlet portion 30A than the opposing second fluid inlet portion 30B, such that once a portion of the fluid being directed to first inlet portion 30A has been diverted through diverter line 134, the flow rate of the remaining fluid received at first inlet portion 30A is about equal to the fluid flow rates received at second inlet portion 30B. For example, in an embodiment and with reference to FIGS. 2C, 14A, and 14B, the dimensions of the first fluid line 31A and diverter line 134 can be such that the fluid flows received at the first and second inlet portions 30A,30B are equal, and the fluid flow received at intermediate inlet portion 130 is twice that of the flow received at each of the first and second inlet portions 30A,30B. In such a configuration, the fluid flow streams from the first and second inlet portions 30A,30B are each met with about an equal opposing fluid flow from the intermediate inlet portion 130. The diverter line 134 can be set up to divert enough fluid to facilitate fluid flow impingement in the bore 34 at the active outlets 40a,40a, prevent the accumulation and packing of sand in dormant areas, and prevent the freezing of fluid in dormant areas. The supplementary diverter line 134 can be a “Y” or lateral connection from the supply lines 31A,31B of the first and/or second inlet portions 30A,30B further promoting fluid to enter the diverter line 134 with reduced abruption.

With reference to FIG. 14B, in another embodiment, the diverter line 134 can be configured to selectively deliver fluid to one or more of a plurality of intermediate inlet portions 130 located along the manifold 10. For example, the diverter line 134 can comprise a single trunk portion 136 diverting part of the fluid from the first fluid line 31A. The trunk portion 136 can then split into multiple branch portions 138, each branch portion 138 in communication with a corresponding intermediate inlet portion 130. Each branch portion 138 can have a branch valve 140 located therealong for selectively permitting flow therethrough, thus permitting the selection of one or more intermediate inlet portions 130 to which fluid will be diverted to.

In embodiments, fluid can be diverted from both first and second inlet fluid lines 31A,31B via the same or different diverter lines 134, and to the same or different intermediate inlet portions 130. For example, with reference to FIG. 14C, fluid is shown being diverted from both fluid lines 31A,31B via diverter line 134 to supply a single intermediate inlet portion 130, or selectively supply two or more intermediate inlet portions 130,130 . . . .

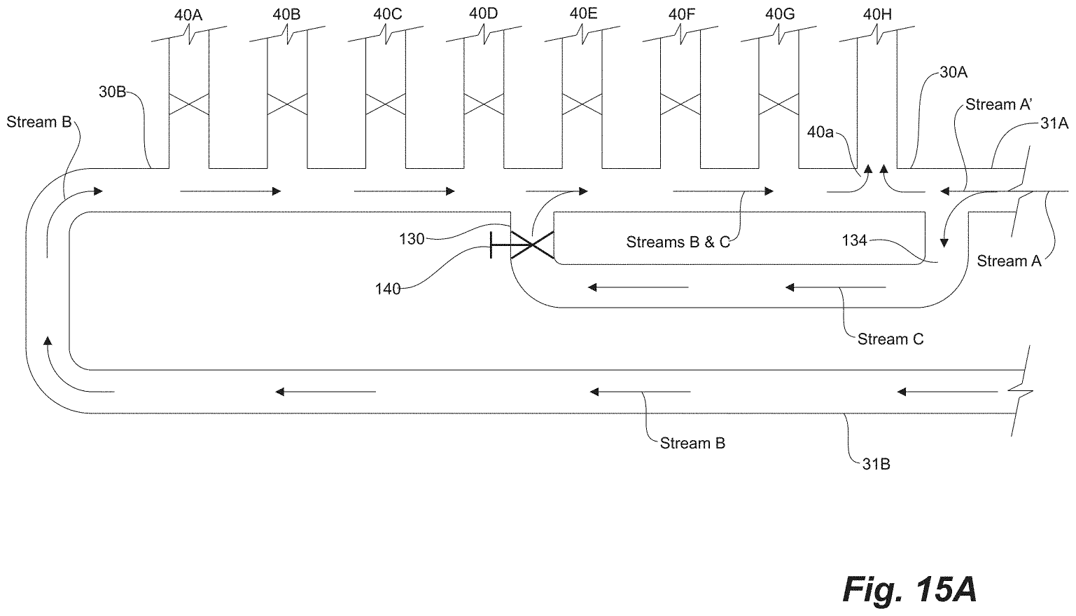

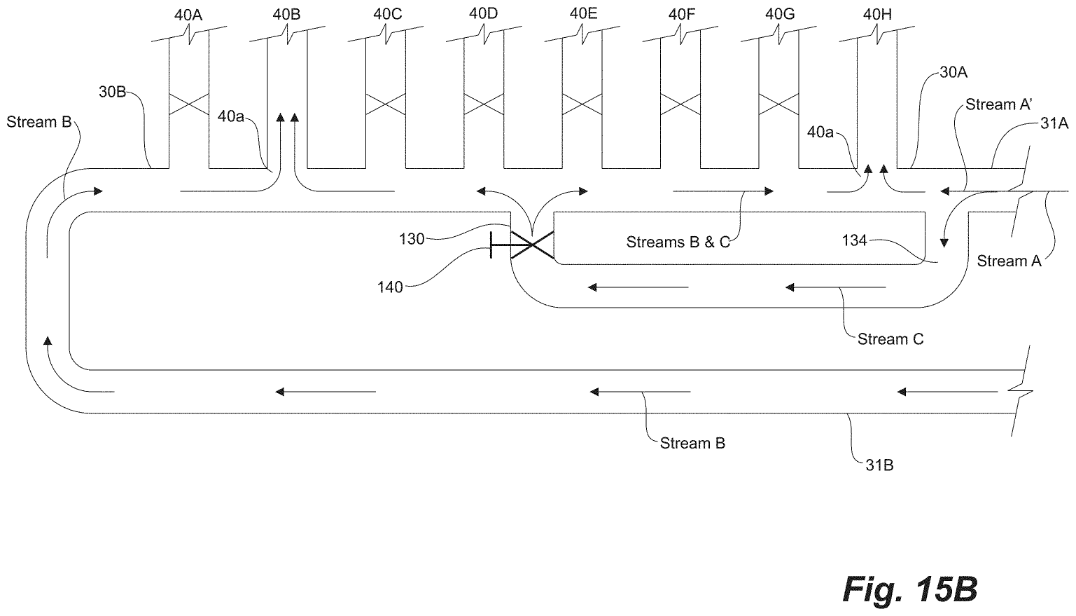

Diverter line 134 can also be used to remedy fluid flow discrepancies in single well treatment operations. Referring to FIG. 15A, in an embodiment, manifold 10 comprises eight fluid outlet portions 40A . . . 40H, each corresponding to a respective well W. In this embodiment, fluid is supplied to the manifold 10 at first and second inlet portions 30A and 30B and one selected well is treated at a time. As can be seen in FIG. 15, the distance travelled from the fluid source 12 to first inlet portion 30A is shorter than the distance travelled to second inlet portion 30B. More particularly, the fluid travelling to second inlet portion 30B traverses an additional distance about equal to the entire length of the manifold 10 before turning to reach second inlet portion 30B. It is common to provide fluid to wells in such piping configurations to reduce the overall length of piping required. To have proper fluid impingement characteristics in this configuration, it is desirable that the fluid streams converging at each active outlet portion 40a have similar fluid flow rates. On larger wellpads, this can be difficult to accomplish with travel paths of widely varying lengths depending on which well is selected. For example, respecting fluid outlet 40H, fluid F provided from first inlet portion 30A (stream A) is much closer to the fluid source 12 than fluid provided from second inlet portion 30B (stream B), which must travel through an additional line length about equal to the length of the manifold 10, then travel through nearly the entire length of the manifold bore 34 to reach outlet 40H. The additional distance travelled by stream B results in decreased flow rate upon reaching second inlet portion 30B due to line resistance and other factors. To compensate, stream B may be provided at a higher initial flow rate. However, it is often not practical or feasible to provide stream A and stream B at different volume flow rates. As a result of the different flow rates of streams A and B arriving at the outlet 40H, there may be insufficient fluid impingement and consequent undesirable erosion characteristics in the area of the manifold bore 34 adjacent fluid outlet portion 40H. Similar detrimental effects may occur when treating outlets 40E, 40F, and 40G.

In the embodiment shown in FIG. 15A, supplementary diverter line 134 can be used to divert fluid from stream A to an intermediate location in the manifold bore 34, in this case to intermediate inlet portion 130 located between outlet portions 40D and 40E, to equalize the flow rates of the converging streams when treating wells through outlet portions 40E, 40F, 40G, and 40H, and thereby improve erosion characteristics thereat. Some of the fluid received at first inlet portion 30A is diverted as stream C through the diverter line 134 to intermediate inlet portion 130, while the remainder of the fluid proceeds to first inlet portion 30A as stream A′. This reduces the flow rate of stream A′ at the outlets 40D, 40E, 40F, and 40H, and supplements the flow rate of stream B at same. The supplementary diverter line 134 also allows the use of a larger bore for entry to second inlet portion 30A and the use of a smaller bore at inlet portion 30B, thereby reducing costs and allowing for a quicker assembly.

The diverter line 134 addresses the problem of unequal flow volume of streams A and B when they meet at the fluid outlets 40E . . . 40H, due at least in part to line friction and other resistive factors encountered by fluid travelling through different flow paths to reach outlets 40E . . . 40H. Having equal or similar volume flow rates of streams A and B arriving at each fluid outlet 40E . . . 40H when they are active is desirable as streams A and B would impinge and nullify each other's' kinetic energy when they meet before proceeding to the corresponding well.

Respecting fluid outlets 40E . . . 40H, the diverter line 134 diverts some fluid away from the fluid received at inlet 30B and contributes it to fluid received from the inlet 30A. This can be used to equalize the flow rates of the two streams. The flow in the supplementary diverter line 134 is kept in the correct direction (from the inlet 30B towards intermediate inlet 130) since the stream B has a higher flow rate than stream A. As one of skill in the art would understand, the intermediate inlet portion 130 can be positioned at any point along the bore 34 as required to equalize the incoming flow streams at the outlet portions 40. While the intermediate inlet portion 130 is shown as being located between outlet portions 40D and 40E in FIG. 15, it could also be located between second inlet portion 30B and outlet portion 40A or anywhere else along the bore 34 to provide the desired stream equalization characteristics. In embodiments, as shown in FIG. 15B, diverter line 134 can be sized to function both to mitigate dormant portions of the live bore 34 during the simultaneous treatment of multiple wells, as well as to equalize flow rates of the fluid streams converging at a particular fluid outlet 40 that would otherwise be unbalanced due to line losses experienced by a particular stream.

As described in greater detail below, the sizing of the fluid lines 31A,31B and diverter line 134, if present, can be selected to provide the desired fluid flow and fluid stream impingement characteristics in the flow system. Fluid system piping generally has smaller diameter bores requiring several lines to provide the same cross sectional fluid flow area that a larger bore can provide. For example, piping generally has 2.5″ inner diameter bores and fracturing manifold bores generally have 4″, 5″ and 7″ inner diameter bores. With reference to FIG. 13A, in an exemplary configuration for the simultaneous fracturing of two wells using three distinct fluid lines 31 leading from fracturing fluid source 12 to inlet portions 30A,30B and intermediate inlet portion 130, the fluid inlet portions 30A, 30B can each have a single inlet port 38 with a 5″ bore (having a 19 square inch cross section) while the supplementary diverter line 134 has a 7″ bore (having a 38 square inch cross section). Such dimensions result in twice the flow arriving at the intermediate inlet portion 130 than at the first and second inlet portions 30A,30B, such that when the flow from the intermediate inlet portion 130 diverges and proceeds toward the active outlet portions 40a,40a, the flow streams encounter equal or about equal flow streams from the first and second inlet portions 30A,30B.

With reference to FIG. 14A, in an embodiment where a diverter line 134 diverts fluid from first inlet line 31A to intermediate inlet portion 130, first inlet line 31A can have a 7.55″ bore (having a 57 inch cross section), second inlet line 31B can have a 5″ bore (having a 19 square inch cross section), and diverter line can have a 6.16″ bore (having a 38 inch cross section). As above, such dimensions result in twice the flow arriving at the intermediate inlet portion 130 than the first and second inlet portions 30A,30B to provide about equal converging flow streams at the active outlet portions 40a,40a.

For a configuration where a single well is fractured at a time, the supplementary diverter line 134 can be sized to have an equal or smaller cross-sectional flow area than the inlet portions 30A,30B, as it is only assisting with supplying fluid to one well. In embodiments, the fluid line 31 having fluid diverted therefrom by the diverter line 134 can have a greater cross-sectional flow area than that of the inlet portion 30 corresponding therewith such that, when the fluid flow has been diverted from the fluid line 31, the fluid flows through the inlet portions 30A,30B are about equal. For example, the difference in cross-sectional flow area between the fluid line 31 having fluid diverted therefrom and the inlet portion 30 corresponding thereto can be equal or about equal to the cross-sectional flow area of the diverter line 134.

In either the simultaneous or single configuration, the use of a supplementary diverter line 134 dispenses with the need of assembling a separate line from the pumping source that could be a large distance away and reduce the footprint requirements at the manifold assembly area, which may be congested with facilities or other service equipment. Thus, the use of the supplementary diverter line 134 reduces costs of equipment and time of assembly.

### Bore Sizing

Additionally, the velocity of fluid F entering and exiting the manifold bore 34 can be reduced by management of the configuration of fluid inlet portions 30,130 and fluid outlet portions 40, including strategically sizing and orienting inlet ports 38 and outlet ports 44, and selecting the numbers of ports active on any particular fluid inlet portion 30,130 or outlet portion 40. Erosive effects of the frac fluid F can be minimized at the manifold 10 and attached manifold piping as described in greater detail below.

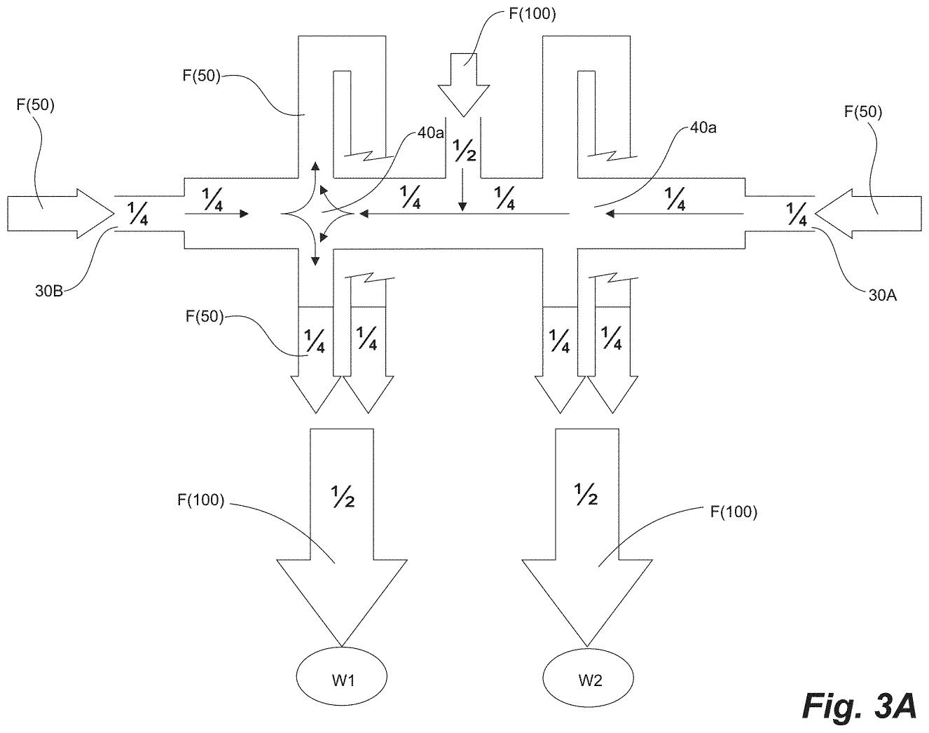

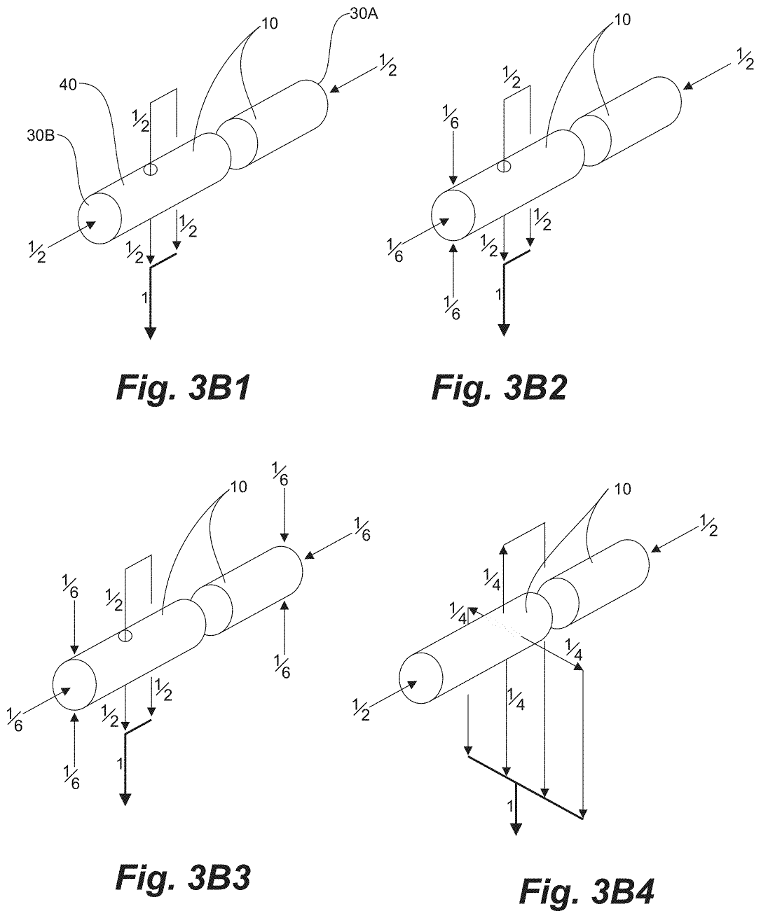

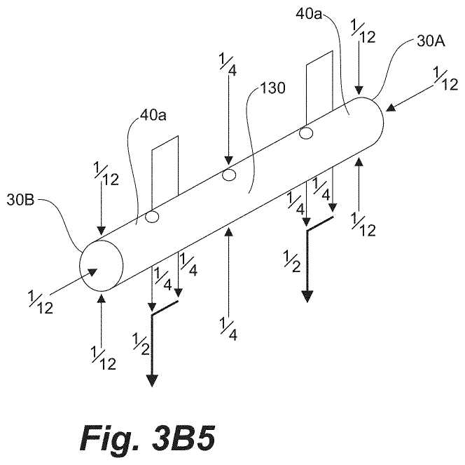

As stated above, and as shown in FIG. 2A and 3A, the manifold 10 can comprise first and second fluid inlet portions 30A,30B located at least at opposing ends 36A,36B of the manifold 10 and a intermediate inlet portion 130 located between the first and second inlet portions 30A,30B. The manifold 10 can comprise a unitary structure, or alternatively a plurality of connector sections or spools 52, having a continuous manifold bore 34 extending axially therethrough. The continuous bore 34 fluidly connects the fluid inlet portions 30,130 and outlet portions 40.

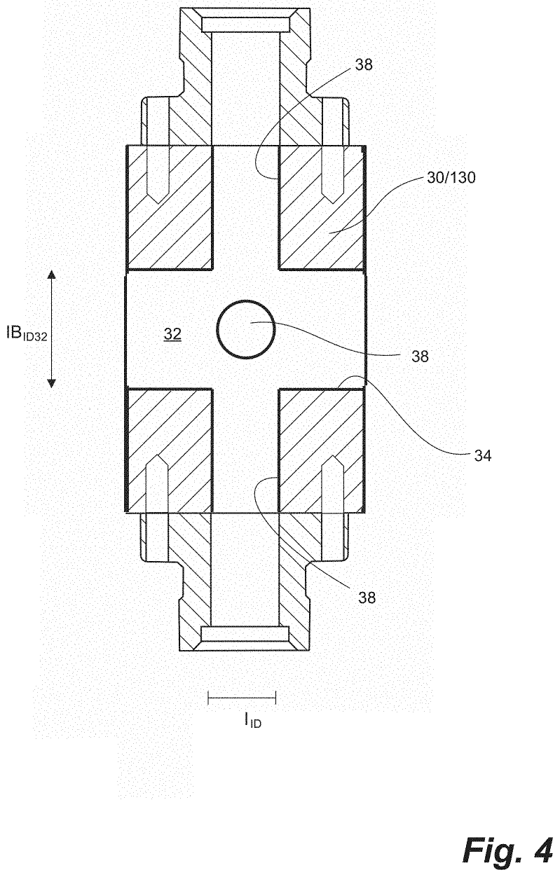

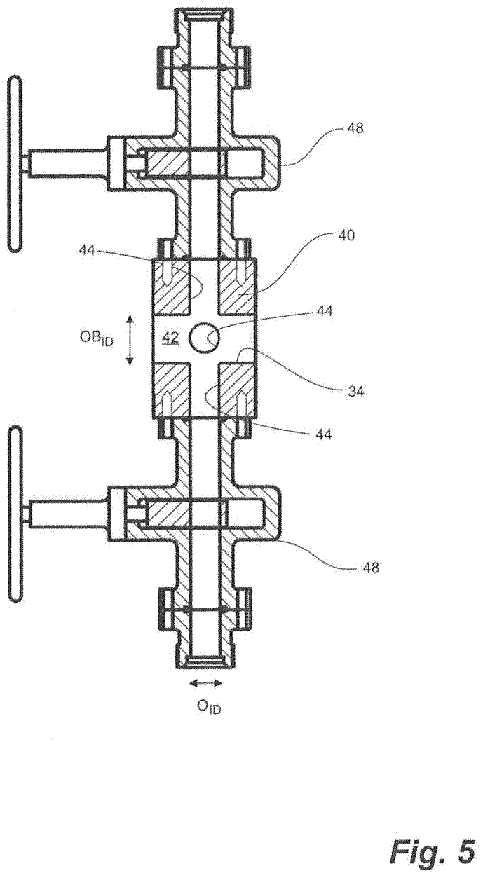

In embodiments, with reference also to FIG. 4, each of the fluid inlet portions 30,130 has an intersecting bore 32 forming a portion of the live manifold bore 34 and multiple inlet ports 38 extending radially therefrom. With reference also to FIG. 5, each of the fluid outlet portions 40 have an intersected bore 42 forming a portion of the live manifold bore 34 and multiple outlet ports 44 extending radially therefrom. The manifold 10 can also comprise connectors 52 each having a connector bore 54 formed longitudinally therethrough which is contiguous with the inlet portion intersected bores 32 and outlet portion intersected bores 42 to form the continuous live bore 34. Connections between fluid inlet portions 30,130, fluid outlets portions 40, connectors 52, inlet valves 39, and outlet valves 48 can be flanged connections or any other connection means known in the art for fluidly connecting components.

While the manifold 10 is comprised of various modular, discrete components as described herein, one of skill in the art would understand that manifold 10 can comprise a mixture of fastened and unitary components, such as welded and bolted configurations, and can also comprise an integral structure.

### Continuous Flow and Flow Impingement

Returning to FIG. 2A and the schematic representations of FIG. 2C, fluid F is supplied to the first and second inlet portions 30A,30B, located at the outboard ends of the two or more fluid outlet portions 40,40 of the manifold 10, and to intermediate inlet portion 130 located intermediate at least two of the outlet portions 40,40. In this embodiment, the first and second inlets 30A,30B straddle the fluid outlet portions 40, the inlet portions 30A,30B shown here to be located at opposing terminal ends 36A,36B of the manifold 10, and the intermediate inlet portion is located at a mid-point of the manifold bore 34 between four outlet portions 40.

Thus, with reference to FIG. 2B and 3A, frac fluid F traverses the manifold 10 from both ends 36A,36B thereof as well as from intermediate inlet portion 130 intermediate the outlet portions 40. For simultaneous stimulation of first and second wells W1,W2 with 100 units of frac fluid each, 50 units of fluid F(50) are provided through the first inlet portion 30A and 50 units of fluid F(50) are provided through the second inlet portion 30B, the inlet portions 30A,30B located at opposing ends of the live bore 34. Additionally, 100 units of fluid F(100) are provided through the intermediate inlet portion 130. Thus, the entire live bore 34 of the manifold 10 is traversed by fluid F and no stagnant/dormant areas result, despite simultaneous treatment of the wells W1,W2.

In addition to avoiding stagnant areas D in the bore 34, the erosive nature of the 200 units of frac fluid F(200) is reduced, as the majority of the live bore 34 experiences a reduced flow rate, reduced fluid velocity, and therefore reduced erosive effects. As the opposing streams of frac flow F(50),F(50),F(50),F(50) from first and second inlet portions 30A,30B and intermediate inlet portion 130 converge at the active fluid outlet portions 40a,40a corresponding to the selected wells W1,W2, each frac flow F(50) through the first and second inlet portions 30A,30B is one quarter the total full frac fluid flow rate F(200) being supplied to the manifold 10, and the frac flow F(100) through the intermediate inlet portion 130 is one half the total frac fluid flow rate F(200). As described below, further mitigation of erosion may be accomplished with multiple inlet ports 38 and multiple outlet ports 44.

As the number of inlet ports 38 increases, the volumetric flow rate and velocity of each stream is inversely proportional to the number of inlet ports 38. For example, as shown in FIG. 2A, fluid F enters manifold 10 at first and second fluid inlet portions 30A,30B having three inlet ports 38,38,38 each, and intermediate inlet portion 130 having two inlet ports 38, for a total of eight inlet ports 38. Therefore, there are eight initial fluid streams into the manifold 10, the flow rate of each stream being a fraction of the total fluid flow rate. The three streams of each fluid inlet portion 30A,30B converge in the intersecting bores 32 thereof to form a fluid stream in the manifold bore 34 having about ¼ the total fluid flow rate and travelling at about ¼ the flow velocity compared to embodiments having only a single inlet stream. The two streams of the intermediate inlet portion 130 converge in the intersecting bore 34 to form a fluid stream having about ½ the total fluid flow rate and travelling at about ½ the flow velocity compared to a single stream.

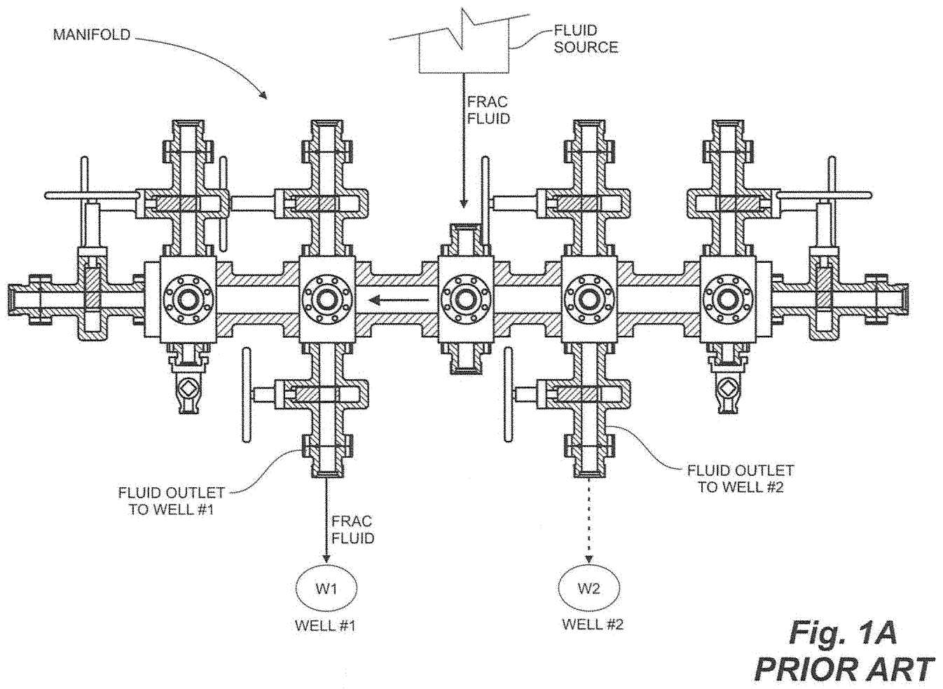

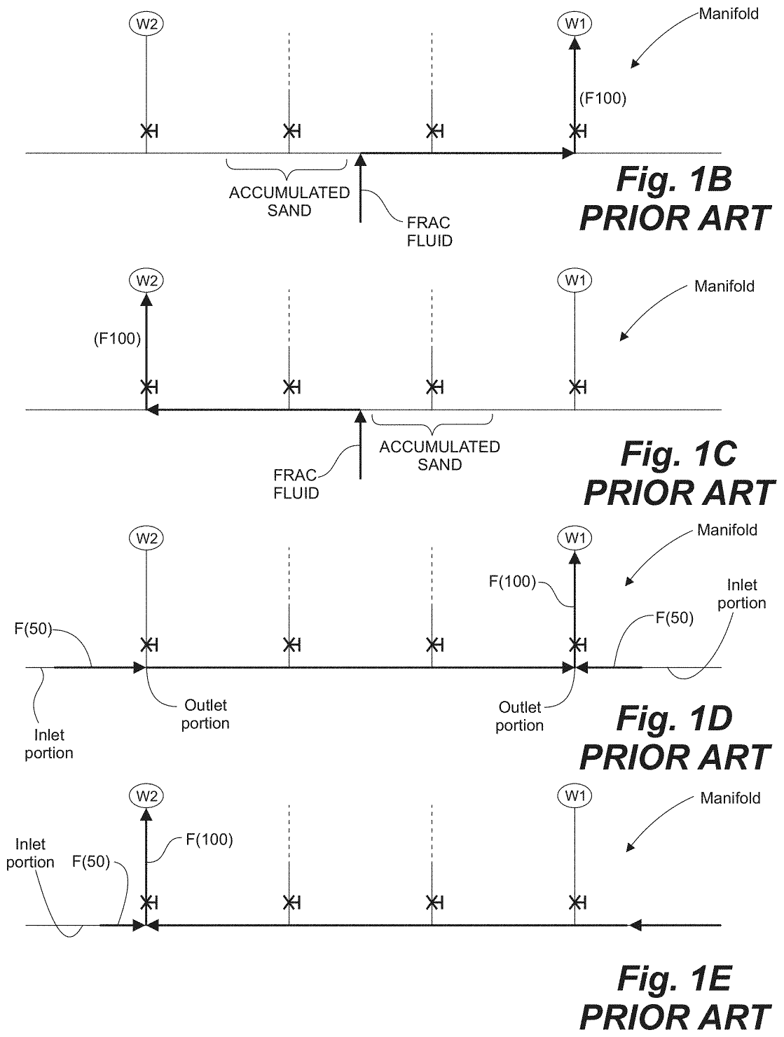

As shown in FIG. 2A, 2C, and 3A even if both wells W1 and W2 are to be supplied by two or more fluid outlet portions 40 on either side of intermediate inlet portion 130, the entire live bore 34 continues to receive a flow of fluid F, thus avoiding deposition and accumulation of sand P and other solids in any part of the live bore 34, the streams from the intermediate inlet portion 130 having generally eliminated stagnant or dead flow areas of any significance. Further, the velocity of the fracturing fluid F as it travels along the live bore 34 is about one-quarter the velocity of fluid flowing through that of the conventional single-inlet manifold system 10 of FIGS. 1A to 1C, thereby reducing the erosive effects of fluid flow on the manifold 10 and other components.

Referring still to FIG. 2A, in the first and second fluid inlet portions 30A,30B, the three streams from inlet ports 38,38,38 converge in the intersecting bore 32 and impinge on each other. Likewise, the two streams from inlet ports 38,38 of intermediate inlet portion 130 converge in the intersecting bore 32 thereof and impinge on each other. Such impingement reduces further reduces fluid velocity and dissipates energy to mitigate erosion of the components of the manifold 10. Similarly, the streams from the opposing fluid inlet portions 30A,30B,130 converge at the active fluid outlet portions 40a,40a corresponding to the selected wells before discharging through the outlet ports 44 thereof, the opposing streams impinging and reducing the erosive energy.

In an embodiment, as best shown in FIG. 4, some or all of the inlet ports 38 are formed in fluid inlet portions 30,130 in opposing pairs such that the fluid streams entering through the opposing inlet ports 38,38 impinge on one another as they enter the live bore 34 to further reduce flow velocity and dissipate energy. In the depicted embodiment, each fluid inlet portion 30,130 has four inlet ports 38 positioned in an opposing arrangement. For first and second inlet portions 30A,30B located at the ends of the live manifold bore 34, an additional fifth inlet port 38 can be oriented in-line with the longitudinal live bore 34. The reduction in velocity and energy caused by the impinging fluid streams further aids in reducing the erosive effects of the fracturing fluid F within the manifold 10 and downstream equipment.

By having multiple inlet ports 38 and outlet ports 44 formed in each fluid inlet portion 30,130 and fluid outlet portion 40, respectively, some or all of the inlet and outlet valves 39,48 can be placed out of axial alignment with the manifold's live bore 34, allowing easier access thereto for maintenance, repair, or replacement, and avoiding direct exposure of the inlet and outlet valves 39,48 to the higher fluid flow rates and velocities of the live bore 34. This is particularly advantageous when the stimulation fluid F is a fracturing fluid carrying sand P, which is highly erosive at high velocity. Further, by strategically sizing the inlets ports 38, outlet ports 44, and live bore 34 as described in detail below, the valves 39,48 and other components of the manifold 10 are subjected to lower velocity flows, reducing wear and erosion.

The selection of the dimensions of the various flow paths and inlet and outlet ports 38,44 can further reduce the erosive effects. Returning to FIG. 4 and with reference to FIG. 5, the inner diameter and cross-sectional area IBXA of the intersecting bore 32 of the fluid inlet portions 30,130 the cross-sectional area OBXA of the intersecting bore 34 fluid outlet portions 40, and cross-sectional areas CXA of the bores of the connectors 52 are substantially equal to and correspond to the diameter and cross-sectional area LBXA of the live bore 34. Thus, the live bore cross-sectional LBXA=IBXA=OBXA=CXA which minimizes flow various and erosion as fluid F flows through the live bore 34.

The intersecting bore 32 of the fluid inlet portions 30,130 can have an internal diameter IBID defining a total cross-sectional area IBXA. Each of the one or more inlet ports 38 can have an internal diameter IID, defining an inlet port cross-sectional area IXA. The cross-sectional area IBXA of the inlet intersecting bore 32 coupled to the live bore 34 is preferably greater than the total combined inlet cross-sectional area TIXA of the inlet ports 38 for reducing the velocity of the frac fluid F entering the fluid inlet intersecting bore 32. Accordingly, as the frac fluid F travels from the relatively smaller total inlet cross-sectional area TIXA into the relatively larger live bore cross-sectional area LBXA, the velocity of the fracturing fluid F decreases.

With reference to FIG. 5, the intersecting bore 42 of the fluid outlet portions 40 can have an internal diameter OBID defining a cross-sectional area OBXA. Each of the one or more outlet ports 44 has an internal diameter OID defining an outlet cross-sectional area OXA. A total combined outlet cross-sectional area TOXA of the outlet ports 44 is preferably greater than the cross-sectional area OBXA. Accordingly, as the frac fluid F travels from the relatively smaller cross-sectional area OBXA of the fluid outlet intersecting bore 42, into the relatively larger total outlet cross-sectional area TOXA, the velocity of the fracturing fluid F is further decreased.

As above, the sizes of inlet ports 38, outlet ports 44, and the size of the live manifold bore 34 can be selected to strategically reduce the velocity of fluid F flowing therethrough. Further, in embodiments, the numbers of inlet ports 38 and outlet ports 44 similarly impact fluid velocities. As shown in FIG. 3B1, with the inlet ports 38 of intermediate inlet portion 130 closed for simplicity of illustration, the two opposing fluid inlet ports 38 of the first and second inlet portions 30A,30B each provide ½ of the nominal flow of frac fluid, whilst two opposing outlet ports 44 of outlet portion 40 each similarly discharge ½ of the nominal flow of frac fluid, combining downstream to deliver the entire total frac fluid to the selected well. As shown in FIG. 3B2, with the intermediate inlet portion 130 still closed to incoming fluid, a first fluid inlet portion 30A provides ½ of the total flow and the second inlet portion 30B is fit with three inlet ports 38, each providing ⅙ of the total flow totaling ½ of the total flow, whilst two opposing outlet ports 44 each similarly discharge ½ of the nominal flow of frac fluid at outlet portion 40, combining downstream to deliver the entire total frac fluid to the selected well. In FIG. 3B3, with the intermediate inlet portion 130 still closed to incoming fluid, each of first and second fluid inlet portions 30A,30B have three inlet ports 38, for providing ⅙ of the total flow at each port. Again, two opposing outlet ports 44 each similarly discharge ½ of the nominal flow of frac fluid at outlet portion 40, combining downstream to deliver the entire total frac fluid to the selected well. In yet another embodiment, illustrating effect of the number of fluid outlet ports 44, with the intermediate inlet portion 130 still closed to incoming fluid, an embodiment is shown in which each fluid inlet portion 30 has one inlet port 38, each of which provides ½ of the total flow; however, the fluid outlet is fit with four outlet ports 44, each of which discharges ¼ of the total flow for combination downstream.

With reference to FIG. 3B5, in a simultaneous treatment operation of two wells via two active outlet portions 40a,40a, first and second inlet portions 30A,30B have three inlet ports 38 and intermediate inlet portion 130 has two inlet ports 38. The first and second inlet portions 30A,30B cumulatively receive ½ of the total flow of the system, such that they each receive ¼ of the total flow and their respective inlet ports 38 receive 1/12 of the total flow. The intermediate inlet port 130 receives ½ of the total flow, such that its respective inlet ports 38 each receive ¼ of the total flow. The intermediate inlet port 130 is located between the two active outlet portions 40a,40a, each outlet portion 40a having two outlet ports 44 discharging ¼ of the total flow. As such, each outlet portion 40 discharges ½ of the total flow of the system to their respective wells, with ½ of the total flow of the system being equal to the requisite amount of flow required for treatment of each well.

The strategic reduction in velocity of the frac fluid F at key locations greatly reduces the erosive effects on the manifold 10 and downstream equipment. As an added benefit, the smaller individual inlet ports 38 and outlet ports 44 can have smaller corresponding valves 39,48, which are less expensive, and easier to remove for repair or replacement.

### Methanol Flush

As above, the bore of the entire manifold 10 remains live, regardless of which well is being stimulated and which is resting. Further, a method is described herein for mitigating freezing of fluids in fracturing lines extending from the manifold 10 to the wellheads or fracturing stacks of a resting well W.

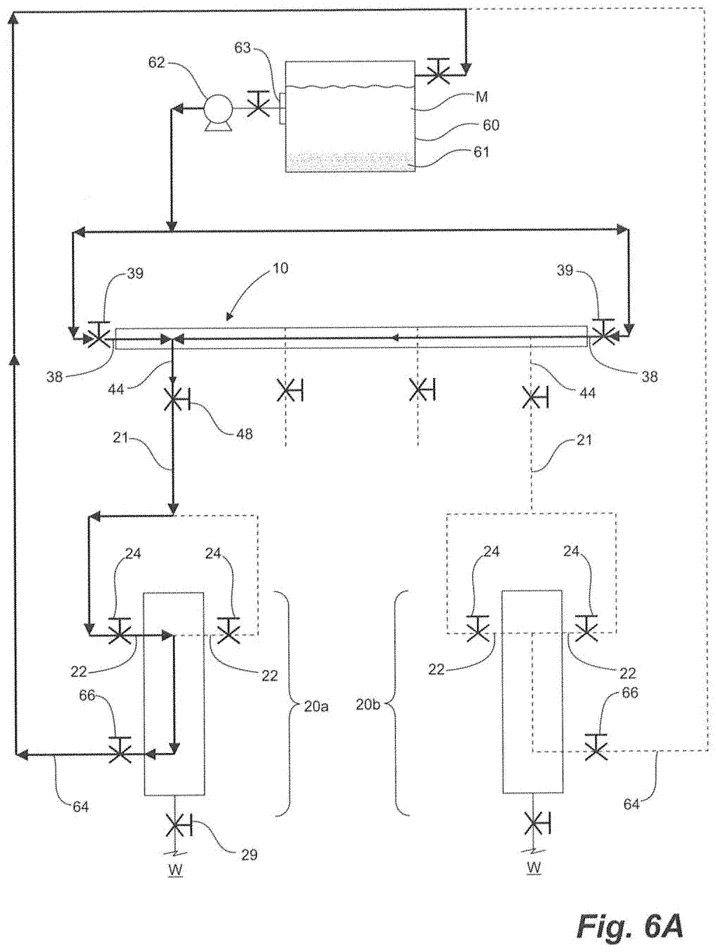

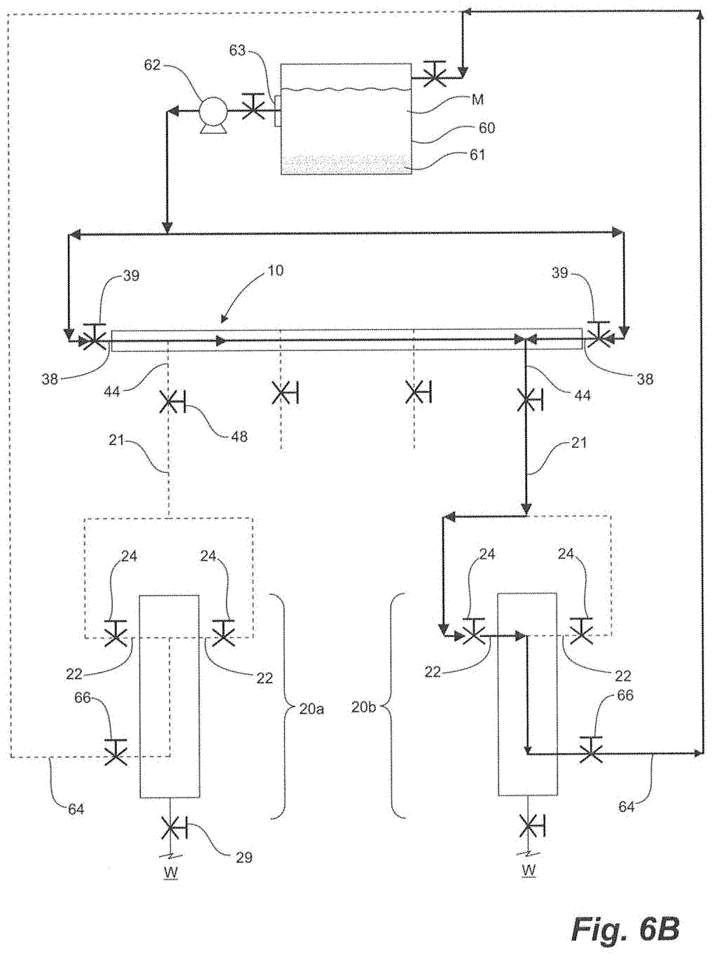

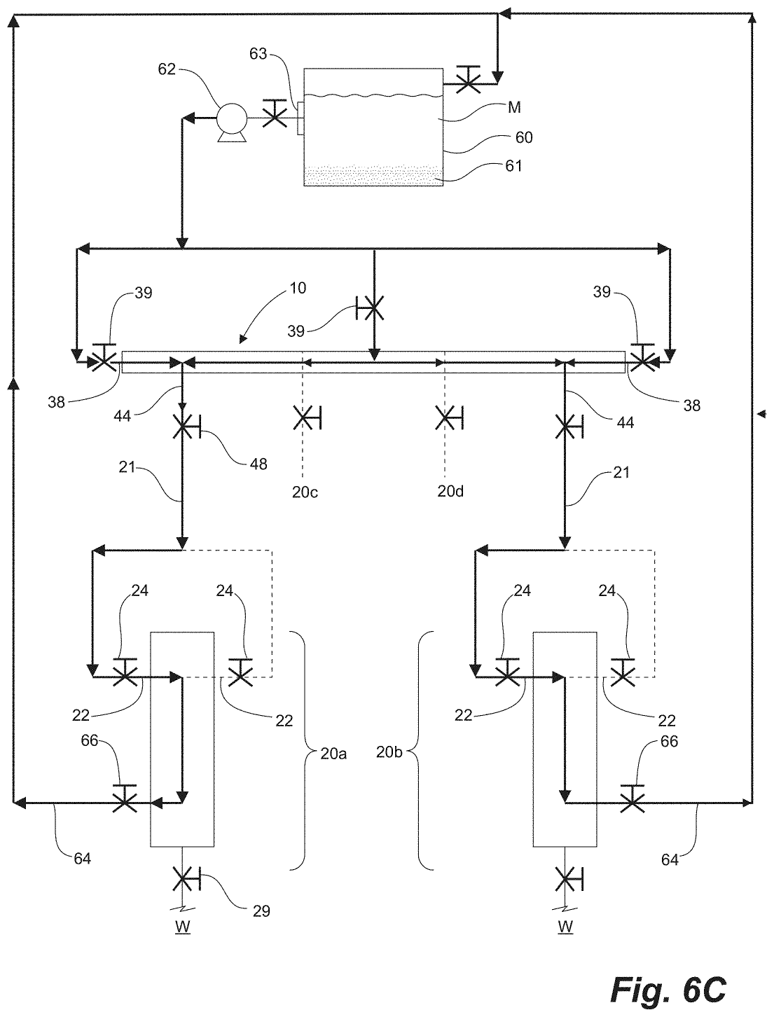

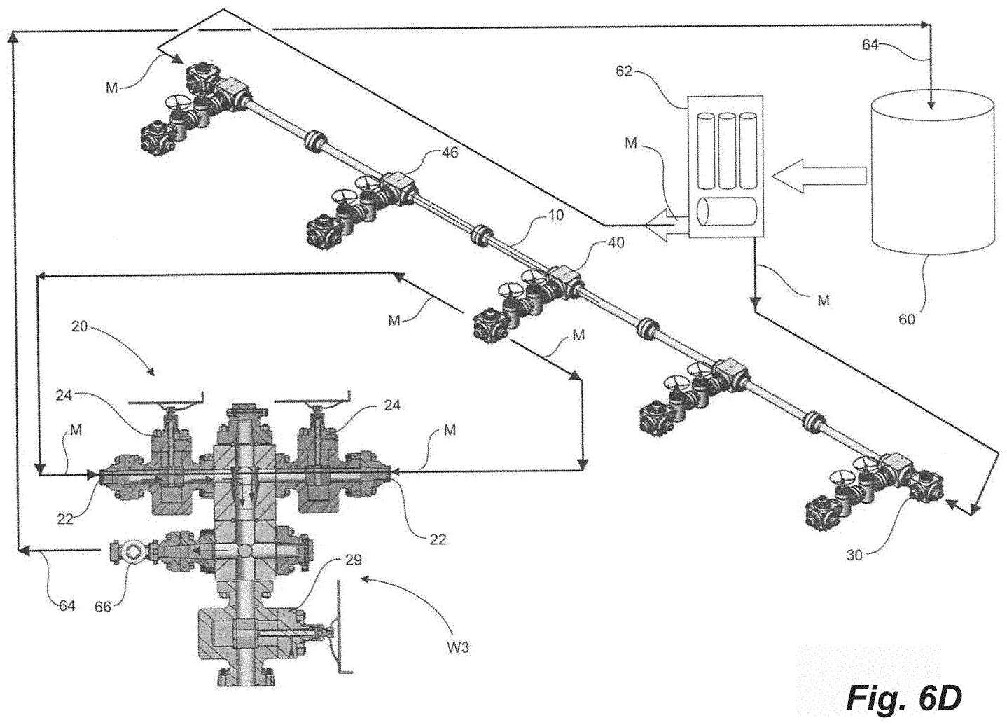

With reference to FIGS. 6A-6D, in embodiments, a methanol-containing fluid M can be circulated through manifold 10 and connecting fracturing lines 21 to select fracturing stacks 20 of wellbores W to prevent the freezing of fluid F therein when a well is in a resting state.

In more detail a tank 60, from a source of methanol of tank 60 containing methanol M, can be fluidly connected to one or more inlet ports 38 of manifold 10. One or more pumps 62 can be fluidly connected to the tank 60 to deliver methanol M to the manifold 10, select fracturing stacks 20, and back into tank 60. Preferably, the methanol tank 60 is fluidly connected to the fluid inlet portions 30A,30B located at the opposing ends of the manifold 10 and, in embodiments, one or more intermediate inlet portions 130 intermediate the inlet portions 30A,30B, such that the entire manifold live bore 34 is exposed to the methanol M regardless of which fracturing stack(s) 20 is selected for flushing, even if it is desired to flush two or more fracturing stacks 20 simultaneously.

Fracturing stacks 20 each have at least one stack inlet 22 in communication with at least one respective outlet port 44 of the manifold 10 via one or more fracturing lines 21. Each inlet can have a corresponding adjacent gate valve 24 for permitting fluid to flow therethrough. Fracturing stacks 20 can further comprise an axial bore 23 in communication with the stack inlets 22 and generally in-line with the wellbore W. One or more return lines 64 connect the axial bore 23 of each of the frac stacks 20 and the methanol tank 60, and one or more fluid return valves 66 can be located adjacent the stack 20 for selectably permitting flow of methanol M from the axial bore 23 back to the methanol tank 60. A wellhead valve 29 is located between each of the fracturing stacks 20 and their respective wellbores W for selectably isolating the axial bore 23 from the wellbore W.

During methanol flushing operations, the return valve 66 of the fracturing stack 20 to be flushed is in the open position and the wellhead valve 29 is in the closed position, such that methanol M flows back to the tank 60 via return line 64 instead of into the wellbore W. In the embodiments depicted in FIGS. 6A-6D, the fracturing stacks 20 each have multiple stack inlets, two stack inlets 22,22 shown.

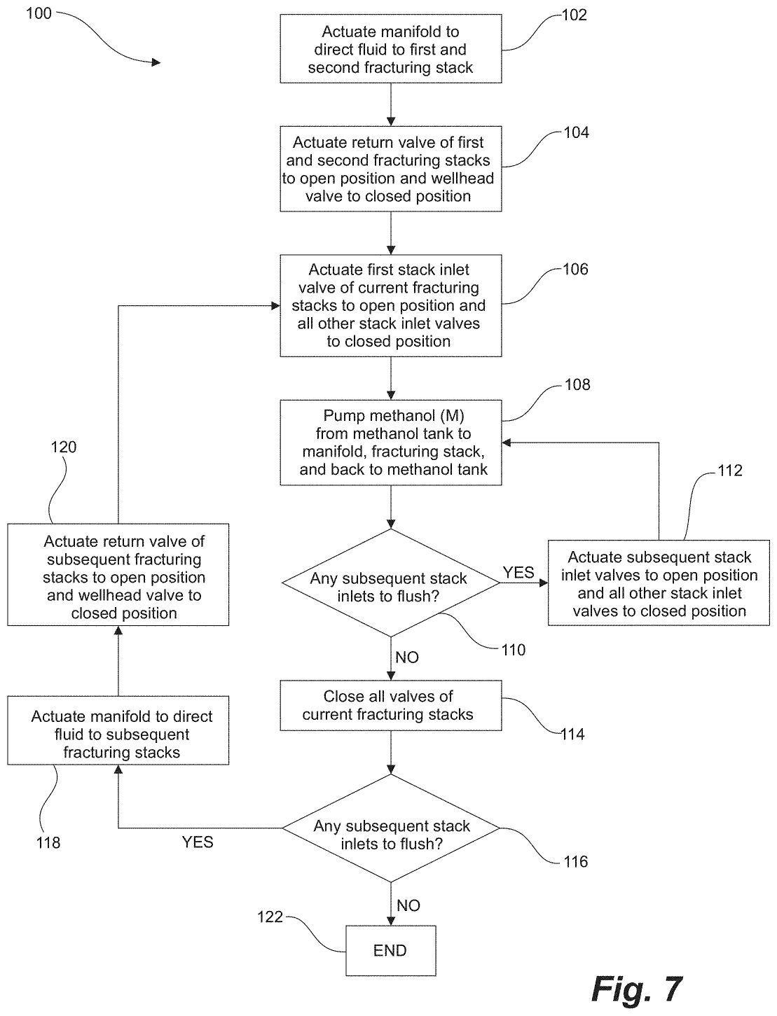

In an embodiment, and as shown in in the schematics of FIG. 6C and flow chart of FIG. 7, a process 100 for flushing a manifold 10 connected to a plurality of fracturing stacks 20 with methanol M is now described. The outlet valves 48 of the manifold 10 can be actuated to direct fluid to a first fracturing stack 20a and second fracturing stack 20b to be flushed simultaneously (step 102). The return valves 66 of fracturing stacks 20a,20b are actuated to the open position, and the wellhead valves 29 are actuated to the closed position (step 104). In embodiments where fracturing stacks 20 have more than one fracturing stack inlet 22, methanol M is preferably flowed through each fracturing stack inlet 22 individually. Thus, a first gate valve 24 of the first inlet 22 of frac stacks 20a,20b are actuated to the open position to receive methanol M while all other gate valves 24 remain closed (step 106). Methanol M can then be pumped through the inlets 38 of manifold 10 and subsequently flow through the one or more outlet portions 40 corresponding with fracturing stacks 20a,20b (step 108). After exiting the manifold 10, methanol M continues through fracturing line 21 to the selected fracturing stacks 20a,20b. Methanol M flows into frac stacks 20a,20b through their respective first inlets 22 into their axial bores 23, and subsequently is circulated back to methanol tank 60 via their return lines 64.

After flushing through the first inlets 22 is completed, the gate valves 24 corresponding to the first fracturing stack inlets 22 are closed and, if there are subsequent stack inlets 22 to flush (step 110), the gate valves 24 corresponding to the subsequent stack inlets 22 are opened for flushing thereof (step 112). Such sequential flushing of stack inlets 22 continues until all of the gates 24 and inlets 22 of the fracturing stacks 20a,20b have been flushed. This sequential flushing provides a more thorough exposure of the components of the fracturing stacks 20 to the methanol M.

Once methanol flushing on first and second fracturing stacks 20a,20b is completed, return valves 66 and all other valves of the fracturing stacks 20a,20b are closed (step 114) and other operations, such as wireline or stimulation operations, can be performed on the stacks. The methanol M remaining in the manifold 10 and flushed frac stacks 20a,20b can be shut in to keep the lines filled with methanol M and ready for the next stimulation or other process. In this manner, methanol M de-ices and mitigates freezing of residual fluid inside the manifold 10, fracturing lines 21, fracturing stacks 20a,20b and other components.

If it is desired to flush subsequent fracturing stacks, such as stacks 20c,20D (step 116), and as shown in FIG. 6C, manifold 10 can be actuated to fluidly connect the fracturing stack 20 of a subsequent well to methanol tank 60, and the return valve and wellhead valve of the subsequent fracturing stack 20 can be actuated to the open and closed positions, respectively (step 120). The flushing process can then be performed again for the new stack 20. The methanol flushing process can be repeated until the fracturing stacks 20 of all desired wells W have been flushed.

Wellhead valve 29 and other lines and equipment therebelow are not exposed to methanol M. As such components are typically near the relatively warmer ground area, one can conservatively install conventional heating around those components for freezing protection.

In the context of a multi-well fracturing operation, methanol flushing can occur at a well W when it is undergoing maintenance and before wireline operations (e.g. installation of a bridge plug and perforation). For example, in a zipper manifold fracturing operation, wherein an “active” well is stimulated while a “resting well” undergoes maintenance and preparation for a subsequent stimulation stage, the resting well can first be flushed with methanol M for the hours need for stimulation of the active well.

In embodiments, multiple wells can be flushed with methanol M simultaneously by opening the outlet portions 40 corresponding to the wells W to be flushed and following the process 100 set out above for each of said wells W.

Preferably, a source of methanol M in tank 60 initially comprises 100% methanol to permit dilution by the water-based fluids returned to the tank 60 over a series of flushing operations, and is maintained at a concentration of about 40% methanol and preferably above 50% methanol when ambient temperatures are −25° C. or below.

Preferably, before methanol flushing operations begin, sand-laden frac fluid is flushed out of the various supply lines with sand-free frac fluid, otherwise sand may be carried into the methanol tank 60 along with the flushed frac fluid. Tank 60 can be fit with a screen 63 to filter out solids entrained in the methanol M as the fluid is being pumped out, a sump 61 for allowing finer particulates to settle therein, or both. Additionally, methanol M can be drawn from a point in the tank 60 high enough such that solids settled in the sump 61 will not be pumped to the manifold 10 or components downstream. The tank 60 can be cleaned to remove solids on a regular basis, for example at the same time the methanol M is replenished.

Methanol pump 62 or pumps can be conventional, such as an impeller pump capable of flowing methanol Mat a rate of 100 gallons/min at about 100 psig.

As one skilled in the art would understand, multiple manifolds 10 can be used in conjunction in order to service more wells W. Fluid lines used for the methanol flushing system can be hydraulic hoses rated for 200-300 psi, with the view of being durable and easy to move.

### Swivel Joint

Flanged swivel joints 70 can be employed in the system at various locations along the fracturing lines 21 connecting the manifold 10 and the fracturing stacks 20. Such flanged swivels 70 further mitigate leaks, ingestion of seals and localized velocity increases, as sections of reduced bore diameter present in conventional swivel joints having wing-union connections are absent. As shown in FIG. 9, the swivel comprises two 90 degrees sections, each section having a distal end terminating at a circumferential distal swivel and a flange, and the proximal ends connected at a proximal swivel for providing a U-shaped fitting infinitely rotatable 360 degrees at the proximal swivel. The swivel can be U-shaped with the distal flanges parallel and aligned in the same plane, through 90 degrees with the flanges at 90 degrees to one another, and rotatable 180 of the 360 degrees to form an S-shape with the flanges parallel, the planes of which are spaced.

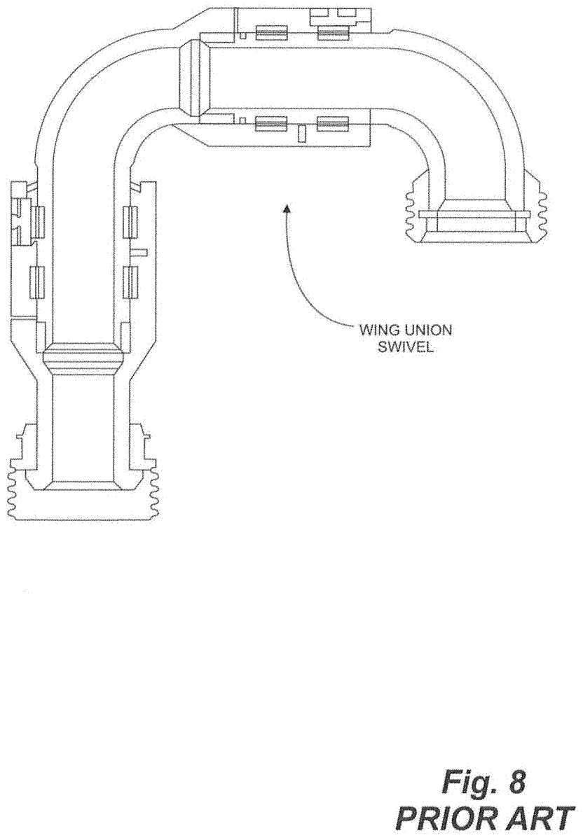

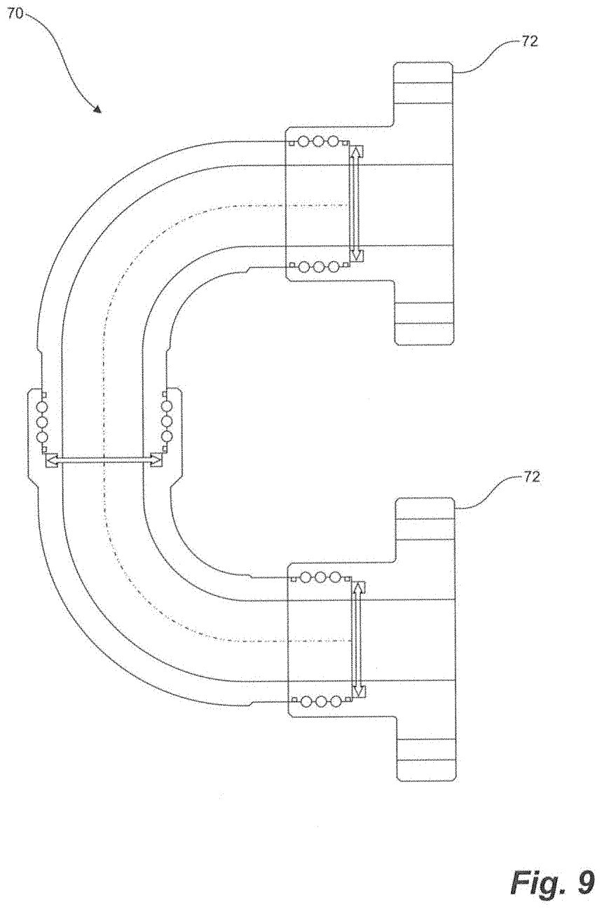

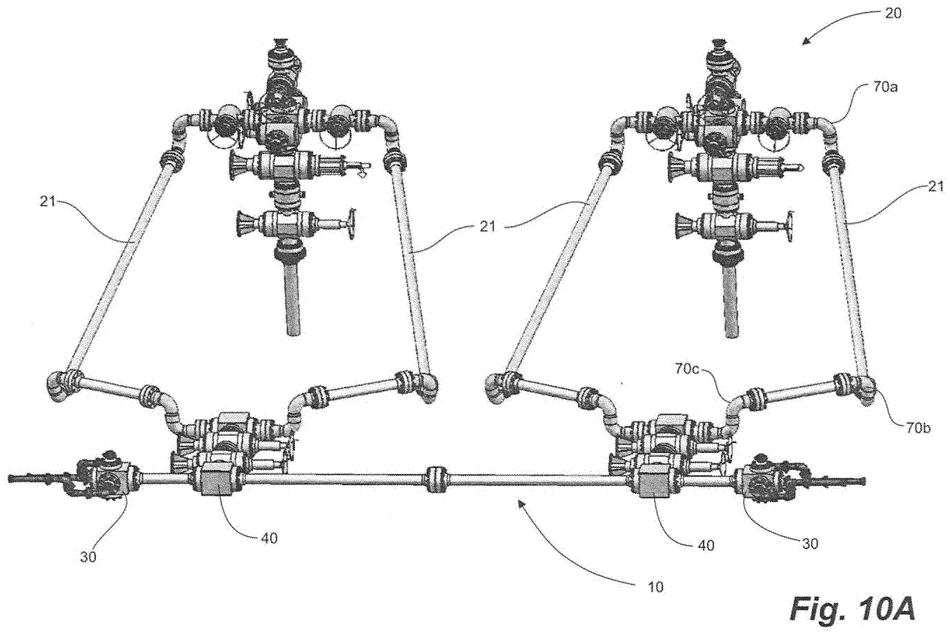

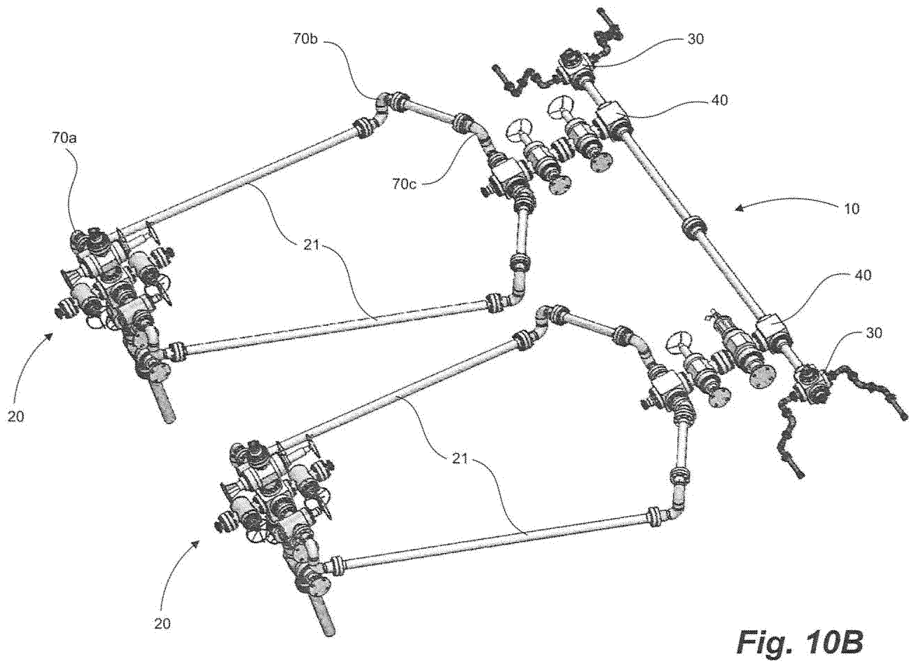

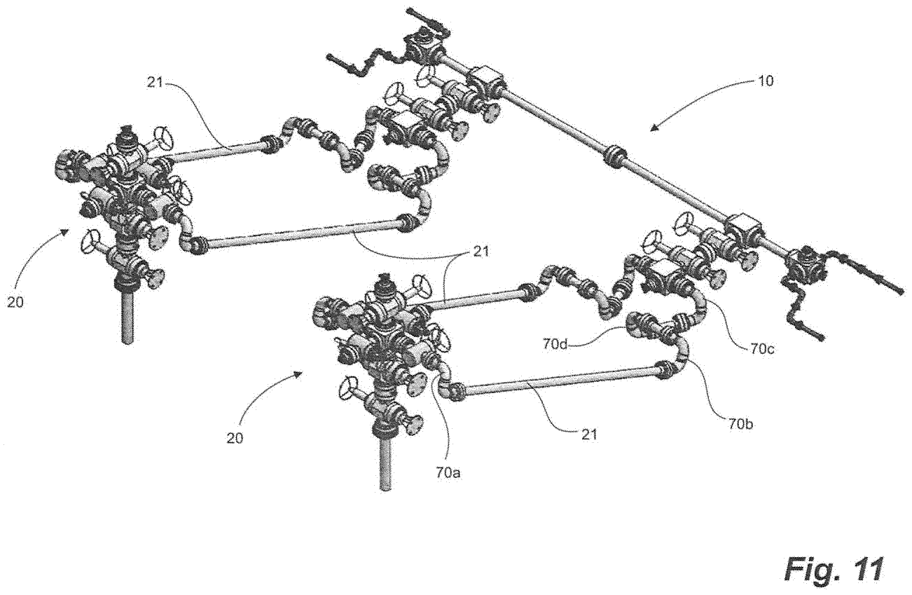

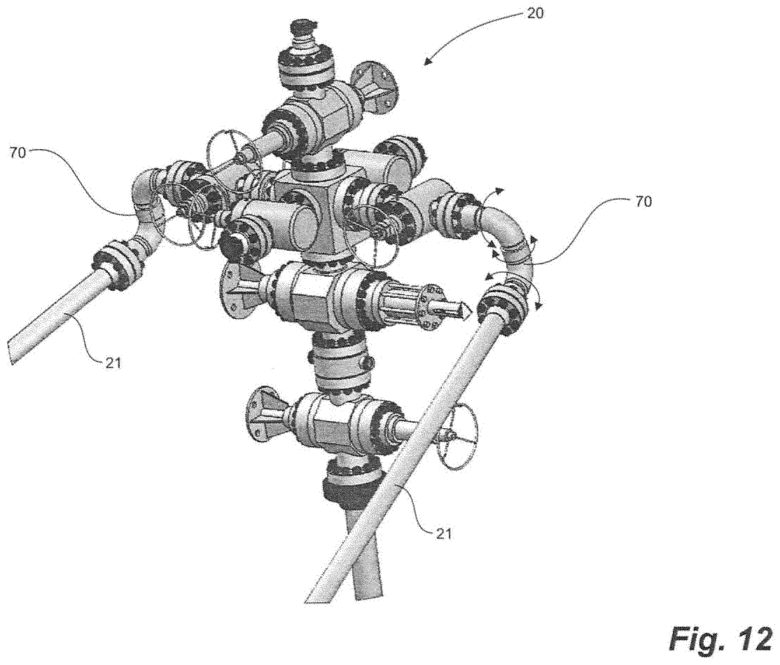

With reference to FIGS. 10A to 12, herein, embodiments of a flanged swivel joint 70, such as that of FIG. 9, provide a strong, safe and easily configured system for connection between a manifold 10 and a fracturing stack 20. Swivel joint 70 has flanged connections 72 at both ends for connection to various components and connection lines such as fracturing lines 21. By eliminating the unreliable and weak wing union connections of prior art swivel joints, as shown in the prior art swivel of FIG. 8, fittings can be specified and bore diameters can be strategically matched or varied relative to the bore diameters of upstream and downstream piping for reducing or maintaining local fluid velocities and avoiding resultant erosion hot spots. The use of flanged connections 72 also allow for larger inner bore diameters while maintaining similar outer diameter as the inlets to the fracturing stacks 20. In the prior wing union case a reduction of inner bore diameter is required near the connecting ends to accommodate the wing. The relatively increased bore diameter of the flanged swivel 70 allows a lower flow velocity to achieve the same rate of flow.

For example, the inside diameter of a prior art nominal 4″ inner-diameter Weco 1502 swivel joint has an inner-diameter of about 3.25 or 3.5″ near the connecting ends, which allows a 6 m³/min flow rate at 52 fps. However, a same-diameter nominal 4″ flanged swivel joint 70, with the larger inside diameter, is able to maintain the same flow rate at a velocity of 40 fps throughout the joint, with no local velocity increases at the connecting ends. Increased capacity is available, while suffering the same erosive rate as the lower flow rate of the conventional swivels. Velocity in the flanged joint 70 can be increased to 52 fps to achieve a flow rate of 7.75 m³/min. The flanged swivel joint 70 is also easier to secure to connected components, as no hammering is required, and alignment with components can be achieved passively by swivel rotation while the flanges are cinched square to the connecting flange.

The flanged swivels 70 are manufactured with large enough bore diameters to maintain low flow velocity (preferably less than 50 feet per second) as the typical sand laden fracturing fluids F are pumped therethrough at high rates and for periods of time.

One or more swivel joints 70 can be implemented at each end of the connection between the fracturing stack 20 and manifold 10 to allow the connection line 21 to move in all directions and accommodate line jack movement and vibration for reducing introduced stresses on the substantially rigid fracturing stack 20 and connections including the connection lines 21 to the fixed manifold 10. Movement is accommodated by providing freedom of movement between the manifold and the fracturing stack 20

The flanged swivels 70 are connected to a block face or other flange of the conventional equipment, utilizing a conventional ring seal 74, such as a stainless steel ring gasket, that is much stronger and more reliable than wing union seals.

The flange connections 72 enable ease of installation with the connection line 21 and/or other components, even with initial misalignments, as the flanged connection 72 can cinched up with one or more bolts while the swivel 70 adjusts to force the line 21 into proper alignment. The stronger and leak-proof connections 72 enable providing connections of line 21 in combinations and arrangements including at least one swivel 70 at each end of the long line joint between the manifold 10 and fracturing stack 20.

Further, the security of the flanged connection 72 enables limiting wing swivel to a single swivel connection 70, additional degrees of freedom being provided by bolting flange-to-flange another intermediate swivel 70 for maximum angular flexibility.

As shown in FIGS. 9, 10A and 10B, for example a three-way swivel 70a could mount between an elevated fracturing stack 20 and fracturing line connection 21 which extends to the manifold 10 typically at ground level. A second swivel 70b can be located at the end of the long joint of line 21, on the ground, adjacent the manifold 10, and a third swivel 70c can be located adjacent the manifold fluid outlet 40. The two joints 70b and 70c enable free longitudinal growth of line 21.

In a further embodiment, as shown in FIG. 11, additional swivel joints 70d can be combined together with the fracturing stack swivel 70a, and the fluid outlet swivels 70b,70c, to provide additional angular degree of freedom to fracturing line 21.

As a result of the high flexibility of the high pressure connections using the high-flow flanges swivels, a safe reliable fracturing system ins achieved that that includes higher reliability, longer periods between maintenance cycles and the ability to absorb jack and vibration.

We claim:

1. A system for delivering fluid from a fluid source to two or more wells, comprising:
a manifold having a main axial bore;
a first inlet portion located at a first end of the manifold and a second inlet portion located at a second end of the manifold;
two or more outlet portions, comprising at least a first outlet portion in communication with a first well of the two or more wells and a second outlet portion in communication with a second well of the two or more wells;
at least one intermediate inlet portion located intermediate the first outlet portion and the second outlet portion;
wherein the first, second, and at least one intermediate inlet portions are in communication with the fluid source.

2. The system of claim 1, wherein:
the two or more outlet portions comprise a plurality of outlet portions, each outlet portion in communication with a respective one of the two or more wells; and
the at least one intermediate inlet portion comprises a plurality of inlet portions, each inlet portion located between a respective pair of outlet portions of the plurality of outlet portions.

3. The system of claim 1, wherein:
the two or more outlet portions comprise a plurality of outlet portions, each outlet portion in communication with a respective one of the two or more wells; and
the at least one intermediate portion comprises an intermediate inlet portion located at an intermediate point between the plurality of outlet portions.

4. The system of claim 1, wherein the first and second inlet portions receive fluid from the fluid source via respective first and second inlet lines, and the at least one intermediate inlet portion receives fluid from the fluid source via a respective at least one intermediate fluid line.

5. The system of claim 1, wherein:
the first and second inlet portions receive fluid from the fluid source via respective first and second inlet lines; and
the at least one intermediate inlet portion receives fluid diverted from one or both of the first and second inlet lines via at least one diverter line.

6. The system of claim 5, wherein the at least one diverter line comprises a trunk line in communication with one or both of the first and second inlet lines and one or more branch lines, each branch line in communication with the trunk line and a corresponding inlet portion of the at least one intermediate inlet portion.

7. The system of claim 1, wherein each outlet portion comprises a corresponding outlet valve configured to selectively permit fluid flow out of the manifold through the outlet portion.

8. The system of claim 1, wherein each intermediate inlet portion comprises a corresponding inlet valve configured to selectively permit fluid flow into the manifold through the intermediate inlet portion.

9. A system for delivering fluid from a fluid source to one or more wells, comprising:
a manifold having a main axial bore;
a first inlet portion located at a first end of the manifold and a second inlet portion located at a second end of the manifold;
one or more outlet portions, each outlet portion in communication with a respective one of the one or more wells;
at least one intermediate inlet portion located intermediate at least one of the one or more outlet portions and the second inlet portion;
wherein the first and second inlet portions are in communication with the fluid source via respective first and second inlet lines; and
wherein the at least one intermediate inlet portion received fluid diverted from one or both of the first and second inlet lines via at least one diverter line.

10. The system of claim 9, wherein the diverter line is configured to divert fluid from the first inlet line, and a bore size of the first inlet line is larger than a bore size of the second inlet line.

11. The system of claim 9, wherein the at least one intermediate inlet portion is located between a pair of outlet portions of the one or more outlet portions.

12. A method for delivering fluid form a fluid source to two or more wells, comprising:
introducing fluid from the fluid source to a manifold at
a first inlet portion located at a first end of the manifold;
a second inlet portion located at a second end of the manifold; and
one or more intermediate inlet portions located between the first inlet portion and the second inlet portion; and
directing fluid out of the manifold via at least two active outlet portions of two or more outlet portions of the manifold, each of the two or more outlet portions in communication with a respective well of the two or more wells;
wherein at least one of the one or more inlet portions is located between the at least two active outlet portions.

13. The method of claim 12, wherein fluid is introduced to the first inlet portion via a first fluid line, and fluid is introduced to the second inlet portion via a second fluid line, and further comprising the step of diverting fluid from one or both of the first and second fluid lines to the at least one or more intermediate inlet portions.

14. The method of claim 13, wherein the second fluid line is longer than the first fluid line, and the step of diverting the fluid comprises diverting fluid from the first fluid line.

15. The method of claim 13, wherein the step of diverting the fluid comprises diverting fluid from the first fluid line, and further comprising providing fluid from the fluid source to the first inlet portion at a first fluid flow rate greater than a second fluid flow rate of fluid provided to the second inlet portion.

16. The method of claim 15, wherein the first flow rate is about three times greater than the second fluid flow rate, and a diverter flow rate through the diverter line is about two times greater than the second flow rate.

17. The method of claim 12, wherein:
the at least two outlet portions comprise at least two groups of outlet portions;
wherein each of the one or more intermediate inlet portions is located between a respective adjacent pair of groups of the at least two groups of outlet portions; and
the at least two active outlet portions comprise at least one outlet portion from each group of the at least two groups of outlet portions.

18. The method of claim 12, wherein each of the one or more intermediate inlet portions is located between a respective adjacent pair of the two or more active outlet portions.

19. The method of claim 12, wherein the fluid flow received at the first and second inlet portions comprises is one-half of the fluid flow to be directed out of each active outlet portion, and the fluid flow received at each of the at least one intermediate inlet portion is equal to the fluid flow to be directed out of each active outlet portion.

20. The method of claim 12, wherein the step of introducing fluid to the one or more intermediate inlet portions further comprises directing fluid through at least one pair of radially opposing inlet ports of the one or more intermediate inlet portions for causing fluid streams travelling therethrough into the manifold to impinge on each other.
